(19) United States
(12) Patent Application Publication
(10) Pub. No.: US 2023/0212366 A1
(43) Pub. Date: Jul. 6, 2023

(54) CELLULOSE FIBER FOAM WITH PAPER-LIKE SKIN AND COMPRESSION MOLDING PROCESS FOR ITS PREPARATION

(71) Applicant: The United States of America, as represented by the Secretary of Agriculture, Washington, DC (US)

(72) Inventor: Gregory M. Glenn, Grand Junction, CO (US)

(21) Appl. No.: 17/876,040

(22) Filed: Jul. 28, 2022

Related U.S. Application Data
(60) Provisional application No. 63/294,900, filed on Dec. 30, 2021.

(51) Int. Cl. C08J 9/34; C08L 1/02; C08J 9/30; C08J 9/00; C08J 9/36

(52) U.S. Cl. CPC C08J 9/34; C08L 1/02; C08J 9/30; C08J 9/0061; C08J 9/0085; C08J 9/365; C08L 2205/16; C08L 2203/14; C08J 2301/02; C08J 2403/02; C08J 2491/06; C08J 2493/02; C08J 2205/05

(57) ABSTRACT

Provided herein is a molded cellulose foam having a smooth, dense surface fiber layer and a low density, open-cell structure interior, a process for compression-molding fiber foam into such molded cellulose foam, articles prepared with such foam, and articles prepared by such process.

### CROSS-REFERENCE TO RELATED APPLICATIONS

This application claims priority to U.S. Provisional Patent Application 63/294,900, filed Dec. 30, 2021, the content of which is expressly incorporated herein by reference in its entirety.

### FIELD OF THE INVENTION

The invention relates to cellulose fiber foams with paper-like skin and a compression molding process for its preparation.

### BACKGROUND OF THE INVENTION

Commodity plastics have become an integral part of nearly every facet of today's consumer products. The extensive use of plastics in single-use items has come under intense scrutiny by environmental groups due to the sheer volume of waste produced and the limited end-of-life options. In 2018 alone, 35.7 million tons of plastic waste were generated in the United States, which accounted for 12.2 percent of the total municipal solid waste (MSW). Only a small amount of plastic recycling occurred, and was primarily restricted to plastic bottles. Paper and paperboard products which are compostable, biodegradable, and made of renewable cellulose fibers have among the highest recycling rates of any materials in the MSW stream. For example, the recycle rate of corrugated boxes is over 96%. Cellulose fiber is also used in plastic composite materials to reduce costs, increase renewable material content, and improve properties. The continued development of cellulose fiber-based materials is needed to further replace plastic products in the marketplace and provide a more sustainable economy.

Foam products are important in many single-use applications in the food packaging and shipping industries due to their light weight, low cost, thermal insulation, and cushioning properties. Most commercial foam products in the market today are made from polystyrene, polyethylene, or polyurethane. One common method of making plastic foam is by extrusion using an appropriate solvent as a foaming agent. Cellulose fiber alone is difficult to process by extrusion and is typically dispersed in a thermoplastic matrix to form extruded composite foam materials. Cellulose fiber can be pre-blended with a compatible foaming agent such as starch and extruded into a foam, but the process is energy intensive, and the foam properties are inconsistent.

Foam products have been made from various renewable materials including starch, wheat gluten, and soy-based polyurethanes among others. Starch/fiber composite foam products were produced from aqueous slurries using a baking process. Fiber foam and foam composites were also made by producing a wet foam and then using a freeze-thaw, freeze-dry, or solvent exchange process to dry the foam and preserve much of the microstructure. These processes are effective in producing cellulose foams with a fine microstructure, especially when incorporating nanocellulose or microfibrillated cellulose (MFC). While the quality of these foams may be excellent, freeze and solvent exchange processes are slow and the use of MFC is expensive.

Another technology for making fiber foam products is by first producing a stable, wet foam from fiber/surfactant slurries and then drying in air or an oven. This foaming process was originally developed to remedy problems associated with fiber flocculation in papermaking, the resulting foams are thermodynamically unstable, and tend to drain due to gravity. Surfactant concentration affects the stability of the foam as well as the incorporation of pickering agents such as cellulose fibers.

Wet fiber foam is typically collected on a screen to allow excess liquid to drain before drying in an oven. Very lightweight foams with large pore sizes and randomly-oriented fibers/pores can be made using this process. However, the foam is soft and has very low compressive strength and excessive shrinkage during the drainage and drying steps due to the high-water content. Fiber foams with greater compressive strength, smaller pore size, and greater dimensional stability may be possible by reducing the moisture content of the foam. However, this results in poor fiber dispersion and foaming volume. Previous studies reported that polyvinyl alcohol (PVA) could improve foaming properties of cellulose foams. PVA is also effective as a dispersing agent for cellulose fiber. Consequently, the use of PVA in low moisture formulations can be effective in producing improved cellulose fiber foam materials.

US Publication No. 2020/0308359 discloses a method of making a foam material from cellulose fiber. The cellulose foam was lightweight, insulative, and similar in rigidity to polyurethane foam cushioning. The fiber foam could have multiple commercial applications, but it would be more useful if there was a way of molding the foam into specific shapes or commercial products.

Compression molding has been used previously to make molded starch/fiber foam composites (U.S. Pat. No. 5,545,450). This method involves making a non-foam aqueous mixture of starch and fiber. The mixture is then deposited in a heated mold. Once the mold closes, the mixture quickly heats and forms a wet foam that expands and flows to fill the voids inside the mold. The mold is designed with vents that allow steam pressure and excess foam to escape. Once the steam has finished venting and the moisture content becomes sufficiently low, the pressure inside the mold decreases and the finished foam product solidifies enabling it to be removed from the mold. Compression molding of plastic foam sheets is a common commercial process. The method involves compressing a foam sheet between two heated platens. The heat softens the plastic foam and allows it to conform to the shape of the mold. The clamping force is enough to shape the foam but not great enough to compress the foam structure. Neither of these compression molding processes are useful for compression molding fiber foam to make a finished product.

Thus, there exists an ongoing need for a molded cellulose foam having a smooth, dense surface fiber layer and a low density, open-cell structure interior, and a compression-molding process for forming it.

### SUMMARY OF THE INVENTION

Provided herein is a molded cellulose foam having a smooth, dense surface fiber layer and a low density, open-cell structure interior, a process for compression-molding wet fiber foam into such molded cellulose foam, and articles of manufacture prepared with such molded cellulose foam.

In an embodiment, the invention relates to a molded cellulose foam having a smooth, dense-fiber layer surface and a low density, open-cell structure interior. In some embodiments of the invention, the molded cellulose foam comprises a pulped fiber component, at least one foaming agent, optionally at least one binding agent, and optionally at least one filler component, where the pulped fiber component forms a matrix with the at least one foaming agent, the optional at least one binding agent, and/or the at least one filler component uniformly dispersed throughout the matrix. In some embodiments of the invention the at least one filler component is a sizing agent and/or a foaming agent. In some embodiments of the invention the at least one binding agent is a starch or a wax.

In an embodiment, the invention relates to a wet cellulose fiber foam press comprising a lower platen assembly comprising a first rigid grid through which liquid can pass set on a flat surface and at least one first perforated sheet through which only liquid can pass set on top of the first rigid grid, a solid frame forming a molding chamber set on top of the first perforated sheet, a mold set inside of the solid frame, and an upper platen assembly comprising at least one second perforated sheet through which only liquid can pass and a second rigid grid through which liquid can pass, where the mold may be part of the solid frame.

In some embodiments of the invention, the first and/or second rigid grid through which liquid can pass in a press of the invention is acrylic plastic, polymethyl methacrylate, polycarbonate, polypropylene, polyethylene terephthalate, polyvinyl chloride, acrylonitrile-butadiene-styrene, metal, wood, or terracotta. In some embodiments of the invention, the first and/or second perforated sheet through which only liquid can pass in a press of the invention is acrylic plastic, polymethyl methacrylate, polycarbonate, polypropylene, polyethylene terephthalate, polyvinyl chloride, acrylonitrile-butadiene-styrene, or metal. In some embodiments of the invention, the solid frame in a press of the invention is wood, metal, ceramic, or plastic. In some embodiments of the invention, at least one metal in the wet fiber foam press is stainless steel. [

In an embodiment, the invention relates to a wet fiber foam press assembled by placing a lower platen assembly comprising a first rigid grid through which liquid can pass on an even surface, with the first rigid grid having its openings perpendicular to the even surface, placing at least one perforated sheet through which only liquid can pass on top of the rigid grid through which liquid can pass, placing a solid frame in direct contact with the first perforated sheet of the lower platen assembly to create a molding chamber, where the molding chamber comprises a mold, either as part of the solid frame, or inserted into the molding chamber, adding wet fiber foam to be molded to the molding chamber, and covering the wet fiber foam to be molded with an upper platen assembly comprising at least one second perforated sheet through which only liquid can pass and a second rigid grid through which liquid can pass, where the second perforated sheet of the upper platen assembly is in direct contact with the wet fiber foam to be molded.

In an embodiment, the invention relates to a method for molding a wet fiber foam using a press of the invention. The method comprises placing a lower platen assembly comprising a first rigid grid through which liquid can pass and at least one perforated sheet through which only liquid can pass on an even surface with the openings of the first rigid grid perpendicular to the even surface, placing a solid frame in direct contact with the a first perforated sheet of the lower platen assembly forming a molding chamber on top of the lower platen assembly, overfilling the molding chamber with wet fiber foam, lowering onto the wet fiber foam an upper platen assembly comprising of at least one second perforated sheet through which only liquid can pass and a second rigid grid through which liquid can pass, with the second perforated sheet in direct contact with the wet fiber foam, and lowering the upper platen assembly onto the wet fiber foam to create a molded fiber foam with a smooth, dense surface fiber layer and a low density, open-cell structure interior; and optionally drying the molded fiber foam. In some embodiments of the invention, the wet foam inserted into the mold has a compressive strength greater than 1.5 kPa.

In an embodiment of the invention, the molded fiber foam with a smooth, dense surface fiber layer and a low density, open-cell structure interior is a liner, a packaging material, a shipping material, a food container, or an insulation. In some embodiments of the invention, the molded fiber foam is a thermal insulation, an acoustic insulation, or an impact insulation. In some embodiments of the invention the molded fiber foam of the invention is a bowl, a tray, a carton, an envelope, a sack, a bag, a baggie, a liner, a partition, a wrapper, a film, a toy, a shipping container cushioning material, or a shipping container packaging material.

### BRIEF DESCRIPTION OF THE DRAWINGS

FIG. 1 depicts a schematic of an illustrative example of a system of the invention for making molded fiber foam with a paper-like skin from wet fiber foams. System 120 comprises a lower platen assembly 121 comprising a rigid grid 123, a perforated sheet 124, and an optional non-rigid screen 125; a solid frame 127 forming a molding chamber and including an optional mold 126; and an upper platen assembly 122 comprising a rigid grid 123, a perforated sheet 124, and an optional non-rigid screen 125.

FIG. 2A to FIG. 2I depict images of the assembly of an illustrative example of a wet fiber foam press of the invention. FIG. 2A depicts an image of a plastic grid (rigid grid through which liquid can pass) located on an even surface at the bottom of the assembly. FIG. 2B shows an image of a rigid lincane perforated aluminum sheet placed on top of the plastic grid. FIG. 2C depicts an image of a silk screen sheet (non-rigid screen) set on top of the perforated aluminum sheet. FIG. 2D depicts an image of a wood frame placed on top of assembly creating a molding chamber. FIG. 2E depicts an image showing wooden blocks used as stops inside of the molding chamber creating a mold. FIG. 2F depicts an image of wet fiber foam added to the molding chamber. FIG. 2G shows a silk screen sheet placed on top of the wet fiber foam inside the molding chamber. FIG. 2H shows a rigid lincane perforated aluminum sheet on top of the silk screen. FIG. 2I shows a plastic grid placed on top of the lincane perforated aluminum sheet.

FIG. 3 depicts an image of a low moisture foam prepared as in Example 2.

FIG. 4A and FIG. 4B show general schemes for the processes of producing compositions comprising at least one renewable fiber, at least one binder, and at least one surfactant described herein. FIG. 4A presents a scheme for producing a high moisture foam. FIG. 4B depicts a scheme for producing a low moisture foam.

FIG. 5 depicts a graph of the compression stress/strain curves obtained for beaded polystyrene and polyurethane foam samples.

FIG. 6 depicts a graph of the compression stress/strain curves obtained for foam samples prepared in Example 1 with “low,” “medium,” “and “high” amounts of paraffin wax as a binder.

FIG. 7 depicts a graph of the compression stress/strain curves obtained for foam samples prepared in Example 1 with “low,” “medium,” and “high” amounts of starch as a binder.

FIG. 8 depicts a graph of the compression stress/strain curves obtained for beaded-PS and for foam samples prepared in Example 1 with “high” amounts of beeswax, starch, and paraffin wax.

FIG. 9 depicts a graph of the compression stress/strain curves obtained for PU foam and for foam samples prepared in Example 2 with “low,” “medium,” “and “high” amounts of paraffin wax as a binder.

FIG. 10A and FIG. 10B depict images of a demolded wet foam sample from Example 4 before and after drying. FIG. 10A shows a demolded wet foam sample (B-4) before placing in oven. FIG. 10B shows the same foam sample after oven drying at 80° C. (Scale bars=2.5 cm.)

FIG. 11 depicts an image of a P-5 low-moisture foam prior to molding. (Scale bar=2.5 cm.)

FIG. 12 depicts images of a perforated bottle mold on the left and a molded fiber foam prepared with the perforated bottle mold on the right. (Scale bar=2.5 cm.)

FIG. 13A and FIG. 13B depict graphs of the drying rate and mineralization rate of P-3 foams. FIG. 13A shows the drying rate of a P-3 sample at 80° C. and at 23° C. The Y axis shows the drying rate, while the X axis shows the drying time in hours. Filled circles indicate 80° C. data and open circles indicate 23° C. data. FIG. 13B shows the mineralization rate of a P-3 sample. The Y axis shows the percent biodegradation (%), while the X axis shows the operational period in days.

FIG. 14A and FIG. 14B depict graphs of the drying rates of B-Series and P-Series foams. FIG. 14A shows the B-Series foam drying rate at 80° C. B-1=triangle; B-2=black triangle; B-3=square; B-4=black square; B-5=black circle; B-6=asterisk; B-7=circle. FIG. 14B shows the P-Series foam drying rate at 80° C. P-1=black triangle; P-2=black square; P-3=square; P-4=black circle; P-5=circle. The Y axis shows the percent cumulative moisture loss (%) while the X axis shows the drying time in minutes (min).

FIG. 15A to FIG. 15F depict images of micrograph foam cross-sections from the B-series and the P-series. FIG. 15A shows a micrograph from a B-1 foam; FIG. 15B shows a micrograph from a B-3 foam; FIG. 15C shows a micrograph from a B-7 foam; FIG. 15D shows a micrograph from a P-1 foam; FIG. 15E shows a micrograph from a P3 foam; FIG. 15F shows a micrograph of a P5 foam. Scale bars=5 mm.

FIG. 16 depicts a graph of the FTIR spectra for cellulose fibers, PVA, and P-5 fiber foam sample surface region, and P-5 fiber foam sample interior region. The Y axis shows the absorbance. The X axis shows the wavenumber per cm (cm⁻¹).

FIG. 17A to FIG. 17D depict images of P4 and B-4 foam samples. FIG. 17A shows a photograph of a P-4 foam sample after trimming with a band saw. Scale bar=2.5 cm. FIG. 17B shows a micrograph of a P-4 foam cross-section. Scale bar=1 mm. FIG. 17C shows a high magnification of a P-4 foam cross-section. The skin layer of PVA and cellulose fibers is denoted by the bracket on the image. Scale bar=500 μm. FIG. 17D shows a micrograph of a B-4 foam cross-section with no PVA. Scale bar=1 mm.

FIG. 18 depicts a graph of the strain curves of P-series samples. P-1=dashed line; P-2=dash-dot line; P-3=double solid line; P-4=dot line; P-5 solid line The Y axis shows the stress in kPa. The X axis shows the percent (%) strain.

### DETAILED DESCRIPTION

The invention relates to molded cellulose fiber foam with paper-like skin and a compression molding process for its preparation. The molded cellulose fiber foam of the invention has a smooth, dense surface fiber layer and a low density, open-cell structure interior.

The inventors surprisingly found that using compression molding of wet fiber foam, the molded fiber foam presented with a paper-like skin. The inventors prepared fiber foam from aqueous softwood pulp fiber mixtures and sodium dodecyl sulfate (SDS) as a foaming agent. The inventors added pulverized wax to some of the wet fiber foams, or added polyvinyl alcohol (PVA) as a fiber dispersant and foaming aid. The PVA was added to formulations with fiber concentrations greater than 7%. A blender was used to make foam containing fiber concentrations ranging from 0.77% to 11%, and a planetary paddle mixer was used to make foam containing fiber concentrations ranging from 14.1% to 23.3%. The wet foam compressive strength was positively correlated with the drying time, dry density, compressive strength, and modulus. A wet foam compressive strength greater than 1.5 kPa was required for compression molding foam panels. The process involved overfilling (about 135%) the mold before lowering the upper platen. As the platen contacted and compressed the foam, sufficient pressure was created for the foam to flow and fill void spaces. Excess foam liquid exuded through the platens as the foam structure collapsed primarily at the platen surface. Compression molding created foam panels with a smooth, dense fiber layer on the surface and a low-density foam interior. The dry foam densities ranged from 0.0062 to 0.075 g/cm3, porosity ranged from 95% to 99.6%, and thermal conductivity ranged from 0.0385 to 0.0421 W/mK.

The molded cellulose foam having a smooth, dense-fiber layer surface and a low density, open-cell structure interior may comprise a pulped cellulose fiber, at least one binding agent, at least one dispersing agent, and optionally at least one filler component, where the fiber, binding agent, dispersing agent, and optional filler component are uniformly dispersed throughout a matrix. In some embodiments of the invention the at least one binding agent may be at least one of starch, PVA, or SDS. The starch may be pea starch, corn starch, wheat starch, or potato starch, among others. The binding agent may also function as a dispersing agent. The starch may be pregelatinized starch. The filler component may be a sizing agent, sand, crushed rock, bauxite, granite, limestone, sandstone, glass beads, mica, clay, alumina, silica, fly ash, fumed silica, kaolin, glass microspheres, hollow glass spheres, porous ceramic spheres, gypsum mono- and dihydrates, insoluble salts, calcium carbonate, magnesium carbonate, calcium hydroxide, calcium aluminate, magnesium carbonate, titanium dioxide, talc, ceramics, pozzolans, zirconium compounds, xonotlite, silicate gels, lightweight expanded clays, perlite, vermiculite, hydraulic cement particles, pumice, zeolites, exfoliated rock, ores, natural minerals, metallic particles, or metallic flakes. The sizing agent may be a wax, rosin, an alkyl ketene dimer (AKD), or an Alkyl Succinic Anhydride (ASA). To prepare molded fiber foams of the invention, pulped fiber and a foaming agent are dispersed in excess water resulting in a wet fiber foam that is molded using the compression molding of the invention.

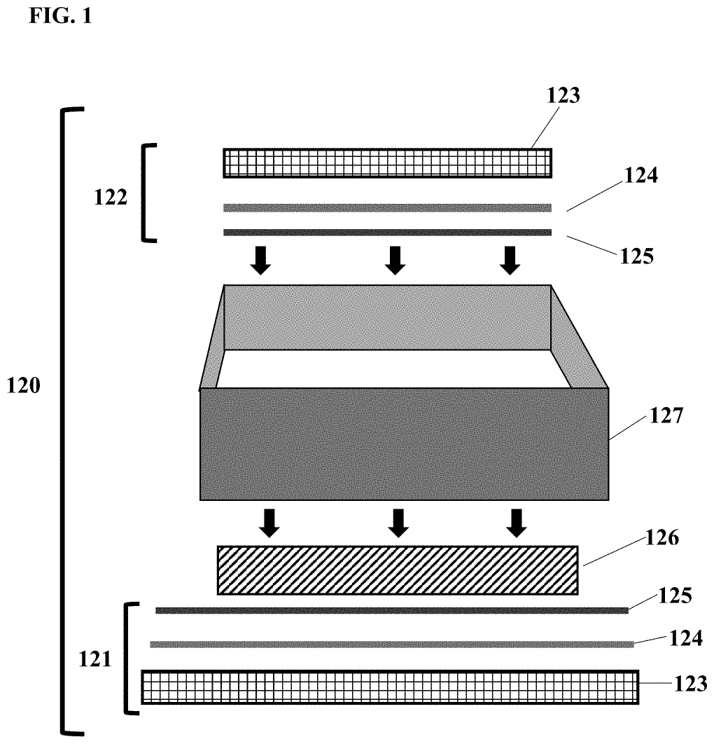

FIG. 1 depicts a schematic of an illustrative example of a system of the invention for making molded fiber foam with a paper-like skin from wet fiber foams. System 120 comprises a lower platen assembly 121 and an upper platen assembly 122. Both platen assemblies comprise a rigid grid 123 and a rigid perforated sheet 124, and may comprise an optional flexible screen 125. To erect the system, a lower platen assembly 121 is constructed by positioning a rigid grid 123 on an even surface, followed by laying a rigid perforated sheet 124 on top of it, and optionally a flexible screen 125 may follow. A solid frame 127 forming a molding chamber is then located on top of the perforated sheet 124 or screen 125 (when present) and a mold 126 inserted in the molding chamber. The wet fiber foam to be molded is added in excess to the molding chamber, and the upper platen assembly 122 is lowered onto the fiber foam with the screen 125 (when present) or perforated sheet 124 of the upper platen assembly in contact with the wet fiber foam.

The rigid grid 123 may be acrylic plastic, polymethyl methacrylate, polycarbonate, polypropylene, polyethylene terephthalate, polyvinyl chloride, acrylonitrile-butadiene-styrene, metal, wood, or terracotta. The rigid perforated sheet 124 and/or flexible screen 125 may be acrylic plastic, polymethyl methacrylate, polycarbonate, polypropylene, polyethylene terephthalate, polyvinyl chloride, acrylonitrile-butadiene-styrene, metal, or silk. The solid frame 127 that encompasses the mold and limits its movement outward may be wood, metal, or plastic. The mold 126 may be loose blocks that are placed against the inner walls of the solid frame 127. Once assembled, the mold pieces form a cavity of the desired shape and are restrained by the solid frame 127, or may be an integral part of the molding chamber formed by the solid frame 127. Once the molding step is completed, the solid frame 127 is removed followed by the removal of the upper platen assembly 122 which can be done by removing the upper platen assembly at once, or by first removing the grid 123, then the rigid perforated sheet 124, and finally the flexible silk screen 125. Next, the blocks that form the mold cavity are carefully removed one-by-one using a spatula until the foam is only resting on the lower assembly 120.

The molded fiber foams of the invention have several environmental benefits compared to various plastic foam materials. The foam is largely made of cellulose fibers that are renewable and compostable. The foaming process involves mechanical mixing of an aqueous mixture containing a surfactant and doesn't require volatile solvents typically used as foaming agents in the production of plastic foams. The fiber foams can be prepared with a large range of physical and mechanical properties that would be attractive for numerous applications. The mechanical and thermal properties of compression molded cellulose fiber foams are promising.

The molded fiber foams of the invention with a smooth, dense surface fiber layer and a low density, open-cell structure interior may be for example, a liner, a packaging material, a shipping material, a food container, or an insulation. A molded fiber foam of the invention may be useful in such things as packing, shipping, acoustical dampening, acoustical soundproofing, exercise mats, exercise equipment mats, compartment/drawer lining, thermal insulation, furniture of cushion padding, arts and crafts, or impact insulation. A molded fiber foam of the invention may be an article of manufacture such as a bowl, a tray, a carton, an envelope, a sack, a bag, a baggie, a liner, a partition, a wrapper, a film, a toy, a shipping container cushioning material, or a shipping container packaging material.

The fiber foam process takes advantage of the ability of a foaming agent such as SDS to form a stable wet fiber foam composite that can be dried without the foam structure collapsing due to surface tension. In the present study, fiber foams with a wide range of physical and mechanical properties were made using different formulations and two different mixing methods. As seen in Table 16, the blender process was a simple, rapid method of making wet foam from formulations containing 11% fiber or less. In contrast, as seen in Table 17, the planetary mixer made it possible to make wet foam samples with more than twice the fiber contents. Interestingly, despite cellulose fiber having a higher density than water, formulations with high fiber contents (P-1 through P-4) had lower wet foam densities than the B-4 to B-7 samples. This result is due to a greater amount of air incorporation (V a) in the wet foams of the P-series compared to the B series samples.

U.S. Pat. No. 5,064,504 relates to the production of molded products using a wood-fiber slurry mixture as the medium, and to a method for manufacturing such molded products from recycled newsprint and other reusable paper products. The patent discloses a pulp press comprising a molding chamber defined on all sides by sidewalls for receiving an aqueous pulp to be compressed, each of the sidewalls being comprised of a rigid screen through which liquid can pass, said screen being the innermost portion of each sidewall, and a rigid impermeable plate outboard from said screen, said rigid impermeable plate having channels formed therein facing said screen through which channels liquid can flow, one of said sidewalls being movable into said molding chamber to serve as a piston, and means to move said movable sidewall.

The inventors have found that a cellulose-based foam material prepared using wax binders integrated as part of the foam and not as a coating, is moisture resistant. When adding a wax binder to an aqueous mixture of cellulose fiber and at least one foaming agent, the inventors found that the components remained uniformly dispersed throughout a matrix; the foam remained stable, and it was possible to dry it in an oven without collapsing. The melted wax did not drain out of the foam or aggregate to the surface of the foam during the oven drying process. The wax remained dispersed throughout the foam during the oven drying process while the water in the wet foam evaporated. The cellulose foam did not collapse, even when a starch binder was absent. Once the foam drying process in the oven was complete, the foam was cooled to room temperature. The solidified wax acted both as a binder and a moisture repellent. As such, the cellulosic foams with integrated binders required no coating or lamination post-processing steps. The final product was a moisture resistant, low-density foam with good insulative properties.

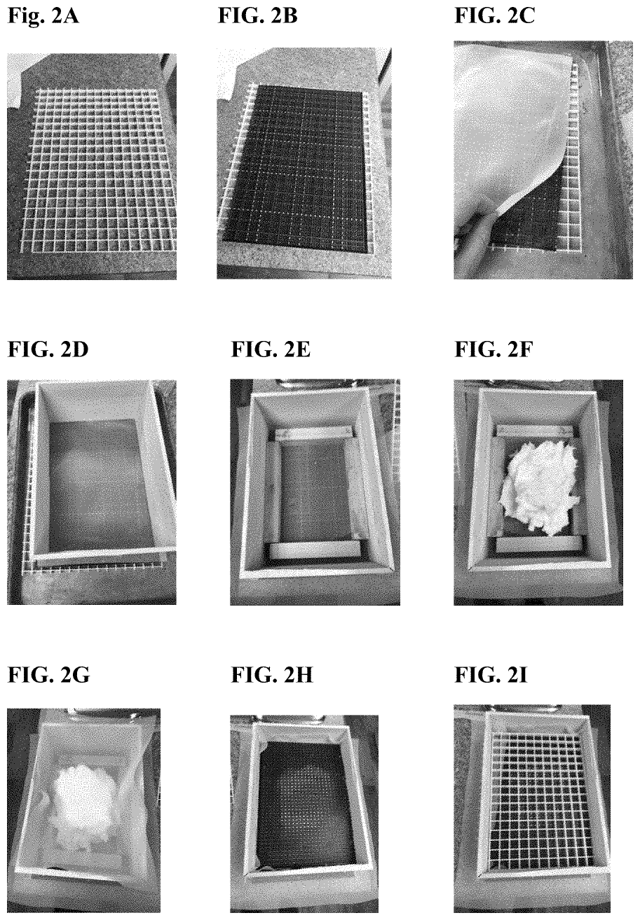

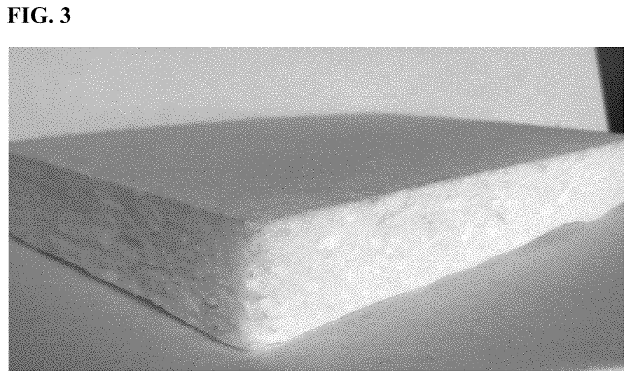

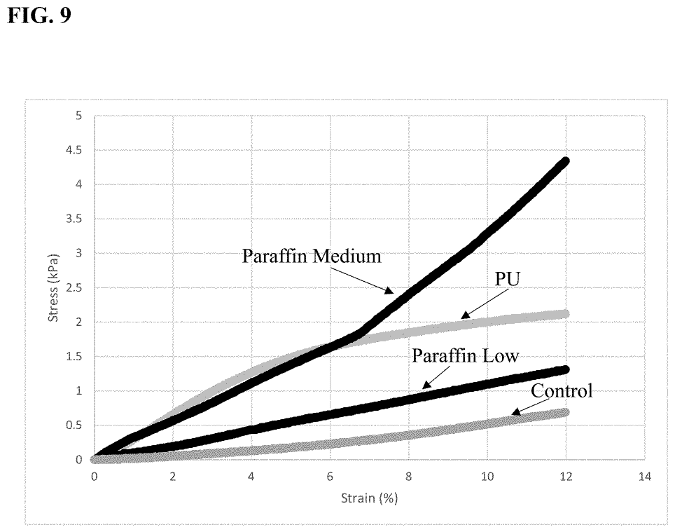

The molded cellulose foam compositions of the invention have a structure similar to commercially available foams. FIG. 2A to FIG. 2I show a frame assembly that may be used in the preparation of the molded foams of the invention. FIG. 2A depicts an image of a rigid grid on the bottom of the assembly. FIG. 2B shows an image of a perforated sheet placed on top of the rigid grid. FIG. 2C depicts an image of a screen on top of the perforated sheet. FIG. 2D depicts an image of a frame placed on top of assembly creating a molding chamber. FIG. 2E shows four wooden blocks used as stops, inside of the wooden frame to create a rectangular mold. FIG. 2F depicts an image of the wet fiber foam in the molding chamber formed by the frame. FIG. 2G shows a screen sheet placed on top of the wet fiber foam. FIG. 2H shows a perforated sheet through which liquid can pass on top of the screen. FIG. 2I shows a rigid grid placed on top of the perforated sheet. FIG. 3 depicts an image of a low moisture foam prepared as in Example 2 using the system depicted in FIG. 1, and assembled following the steps depicted in FIG. 2A to FIG. 21.

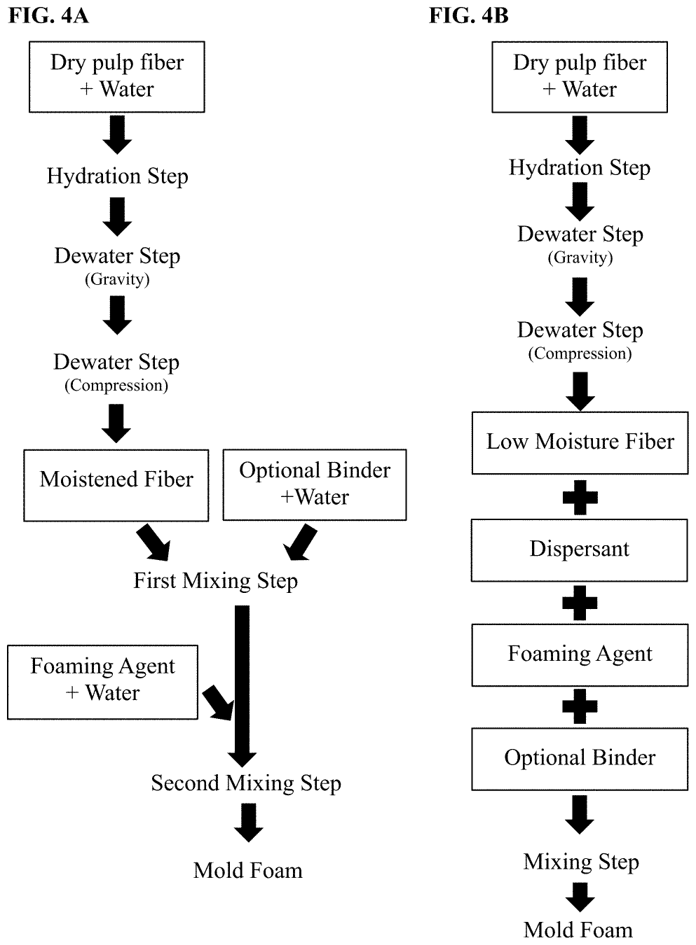

General schemes on how to make foam compositions comprising at least one fiber component, at least one foaming agent, optionally at least one binder, and optionally at least one dispersant; where the components are uniformly dispersed throughout a matrix are shown in FIG. 4A and FIG. 4B. The scheme shown in FIG. 4A is for a high moisture fiber preparation. Dry pulp fiber is mixed with water and allowed to hydrate. The fiber is then dewatered first by gravity and then by compression to obtain a high moisture fiber with at least 5 parts water per every part fiber. A binding agent in water is added to the high moisture fiber followed by a first mixing step. After addition of a foaming agent in water a second mixing step is performed, followed by molding the composition. The scheme shown in FIG. 4B is for a low moisture fiber preparation. Mixing of fiber with water, allowing the fiber to hydrate, and the first (gravity) dewatering step are the same as for the high moisture fiber preparation. Compression in a second dewatering step results in a low moisture fiber containing at least about 1 part water per every part fiber to at least about 4.5 parts water per every part fiber. A dispersant, a foaming agent, and a binding agent are added to the low moisture fiber followed by a mixing step, followed by molding the composition. In both schemes, a drying step follows the molding of the foam to prepare articles of manufacture.

Current methods used for making cellulose foam from a wet foam are effective in making very low-density foams (about less than 0.02 g/cm³). However, the foam is not rigid, and the process does not fit well for making products that have desirable qualities for commercial use. For instance, the large volume of water used for making the foam requires a lengthy dewatering step and, in addition, the foam shrinks considerably during the dewatering step making the foam dimensionally unstable. A considerable amount of the foaming agent or any other additive is also lost in the wastewater during the dewatering step.

Foam compositions comprising at least one fiber component and at least one foaming agent forming a foam/fiber matrix; at least one wax binder uniformly dispersed throughout the foam/fiber matrix; and optionally at least one dispersant are disclosed. Even though the wax binder is not a coating, the foam composition remains water resistant. Wet fiber foam was also made from aqueous softwood pulp fiber mixtures and sodium dodecyl sulfate (SDS) as a foaming agent. Polyvinyl alcohol (PVA) was added as a fiber dispersant and foaming aid in formulations with fiber concentrations greater than 7%. A blender and a planetary paddle mixer were used to make foam containing fiber concentrations ranging from 0.77% to 11% and from 14.1% to 23.3%, respectively. The wet foam compressive strength was positively correlated with the drying time, dry density, compressive strength, and modulus.

The fiber component in the novel molded foams of the invention may be a plant-derived complex carbohydrate such as, wood (such as hardwood, softwood, or combinations thereof), fiber crops (such as sisal, hemp, linen, or combinations thereof), crop waste fibers (such as wheat straw, onion, artichoke, other underutilized fiber sources, or combinations thereof), or other waste products such as paper waste. However, it should be appreciated that any type of fiber known in the art may be utilized for use in the invention. The fiber component in the novel foam compositions of the invention may be at least one of a plant-derived complex carbohydrate, crop waste fibers, wood, lignocellulosic fibrous material, fiber crops, or combinations thereof.

A binder acts as an agent to hold together individual fibers in the foam. Binders normally used in the preparation of foam compositions and may be derived from natural sources such as proteins or starches from corn, wheat, soy, potato, cassava, and pea. As taught herein, preparing a foam composition with a wax binder instead of a starch binder results in a foam composition that is moisture resistant. The at least one wax binder in the foam compositions taught herein is a synthetic or natural waxy substance or a mixture thereof. The at least one binder in the foam compositions may be a paraffin wax, a carnauba wax, a candelilla wax, a beeswax, tallow, a jojoba wax, lanolin, ambergris, a soy wax, a rice bran wax, a laurel wax, a polycarpolactone, a polylactic acid, a polyhydrobutyrate, a polybutylene succinate, or a mixture thereof.

Drying of the molded fiber foams of the invention, especially low-moisture formulations results in a rigid foam with a size similar to that of the wet foam, there is not much shrinkage during the driving step. It is desirable that foam composition of the invention retains a similar volume even after drying to ensure the quality of the foam product made with such foam composition. A container or cushioning material prepared with a foam composition of the invention should be capable of holding its contents, whether stationary, in movement, or while handling, while maintaining its structural integrity and that of the materials contained therein or thereon. This does not mean that the container or cushioning material is required to withstand strong or even minimal external forces. In fact, it can be desirable in some cases for a particular container or cushioning material to be extremely fragile or perishable. The container or cushioning material should, however, be capable of performing the function for which it was intended. The necessary properties can always be designed into the material and structure of the container or cushioning material beforehand.

A container prepared with a foam composition of the invention should also be capable of containing its goods and maintaining its integrity for a sufficient period of time to satisfy its intended use. It will be appreciated that, under certain circumstances, the container can seal the contents from the external environments, and in other circumstances can merely hold or retain the contents.

Molded pulp is fiber-based material that is used for many types of shaped containers such as egg cartons, food service trays, beverage carriers, end caps, trays, plates, bowls, and clamshell containers. Molded pulp packaging is formed into shapes. It does not start as a flat sheet, instead, it is designed with round corners and complex three-dimensional shapes. To prepare molded pulp packaging, the fiber is dispersed in excess water. Molds formed of wire mesh are then lowered into the pulp mixture where vacuum draws the fiber mixture through the wire mesh. As the mixture is drawn through the mold, the fiber component is deposited on the mold surface while the water component is drawn through the mold and diverted into a holding tank. After forming, the parts are wet and need to be dried. Traditional molded pulp packaging such as egg cartons is dried on open-air drying racks. Thin-walled molded pulp packaging such as plates or bowls are dried using automatic, high temperature and high-pressure drying machines. Each product is pressed onto solid metal tools to smooth the surfaces. The foam compositions comprising fiber, at least one foaming agent, optionally at least one binder, and optionally comprising at least one additional dispersant may be used in the preparation of a hybrid of molded pulp/foam packaging.

In an embodiment, the invention relates to a method for molding a wet fiber foam using a wet cellulose fiber foam press. The method comprising stacking a solid frame forming a molding chamber on top of a lower platen assembly set on a flat surface, overfilling the molding chamber with the wet fiber foam, and lowering onto the wet fiber foam an upper platen assembly to create a molded fiber foam with a smooth, dense surface fiber layer and a low density, open-cell structure interior, and optionally drying the molded fiber foam. The lower platen assembly comprising a first rigid grid through which liquid can pass and at least one first perforated sheet through which water only liquid can pass set on top of the first rigid grid, and the upper platen assembly comprising a second perforated sheet through which only liquid can pass and at least one second rigid grid through which liquid can pass set on top of the second perforated sheet. In some embodiments of the invention, the wet cellulose fiber foam press further comprises a first screen sheet located between the first rigid grid and the first perforated sheet on the lower platen assembly, and/or a second screen sheet located between the second perforated sheet and the second rigid grid on the upper platen assembly.

The process for making a high moisture foam composition of the invention may comprise mixing a fiber component in water to create a hydrated fiber; removing excess water from the hydrated fiber to create a high moisture fiber; blending into the high moisture fiber at least one wax binder to create a dispersed binder; and mixing into the dispersed binder at least one foaming agent to create a foam composition. The foam composition may be molded and dried. After removing excess water, the high moisture fiber may comprise at least about 5 parts of water per part of fiber, at least about 6 parts of water per part of fiber, at least about 7 parts of water per part of fiber, at least about 8 parts of water per part of fiber, or a portion thereof.

In an embodiment, the invention relates to a process for making a low moisture foam composition. The process for making a low moisture foam composition of the invention comprises mixing a fiber component in water to create a hydrated fiber; removing excess water from the hydrated fiber to create a low moisture fiber; blending into the low moisture fiber at least one dispersant, at least one foaming agent, and at least one wax binder to create a foam composition. The foam composition may be molded and dried. After removing excess water, the low moisture fiber may comprise at least about 1 part water per part fiber, at least about 2 parts water per part of fiber, at least about 3 parts water per part fiber, at least about 4 parts water per part fiber, at least 4.5 parts water per part fiber, or a portion thereof.

The inventors have developed a compression molding process for making molded fiber foam to mold wet foams having wet compressive strengths greater than 1.5 kPa. The fiber foams have several environmental benefits compared to various plastic foam materials. The foam is largely made of cellulose fibers that are renewable and compostable. The foaming process involves mechanical mixing of an aqueous mixture containing a surfactant and doesn't require volatile solvents typically used as foaming agents in the production of plastic foams. The fiber foams can be prepared with a large range of physical and mechanical properties that would be attractive for numerous applications.

In an embodiment, the invention relates to a molded cellulose foam having a smooth, dense surface fiber layer and a low density, open-cell structure interior. In some embodiments of the invention, the molded cellulose foam having a smooth, dense surface fiber layer and a low density, open-cell structure interior comprises a pulped fiber component, at least one foaming agent, optionally at least one binding agent, and optionally at least one filler component; wherein the pulped fiber component, the at least one foaming agent, the optional at least one binding agent when present, and the optional filler component when present are uniformly dispersed throughout a matrix. In some embodiments of the invention, the pulped fiber component in the molded cellulose foam of the invention is crop waste fibers, wood, fiber crops, or combinations thereof. In some embodiments of the invention, the foaming agent in the molded cellulose foam of the invention is an anionic, cationic, amphoteric, or nonionic surfactant, or based on synthetic, rosin, protein, or composite compounds.

In some embodiments, the invention relates to a molded cellulose foam having a smooth, dense surface fiber layer and a low density, open-cell structure interior comprising comprises polyvinyl alcohol, a pregelatinized starch, a native starch, a chemically modified starch, carboxymethyl cellulose, a carboxymethyl cellulose derivative, hydroxymethyl cellulose, a hydroxymethyl cellulose derivative, xanthan gum, tara gum, alginate, or gelatin. In some embodiments of the invention, the molded cellulose foam having a smooth, dense surface fiber layer and a low density, open-cell structure interior comprises a moisture resistant additive uniformly dispersed throughout the matrix. In some embodiments of the invention the moisture resistant additive uniformly dispersed throughout the matrix in a foam of the invention is a wax emulsion, a rosin emulsion, an alkyl ketone dimer (AKD), an alkyl succinic anhydride (ASA), or a pulverized wax. In some embodiments of the invention, the molded cellulose foam comprises a moisture resistant outer coating applied as a surface moisture barrier. In some embodiments of the invention, the moisture resistant outer coating in the molded cellulose foam of the invention is at least one of a plastic film, a wax, AKD, ASA, or a chemically modified carbohydrate.

In an embodiment, the invention relates to a molded cellulose foam having a smooth, dense surface fiber layer and a low density, open-cell structure interior that is a liner, a packaging material, a shipping material, a food container, or an insulation. In some embodiments of the invention, the molded cellulose foam is a thermal insulation, an acoustic insulation, or an impact insulation.

In an embodiment, the invention relates to a wet cellulose fiber foam press comprised of a porous upper platen, a porous lower platen, and a mold contained between the upper and lower platens. In some embodiments of the invention, the mold in the wet cellulose fiber foam press of the invention is held rigidly in place and when overfilled with a wet foam a positive pressure is created inside the mold during compression action. In some embodiments of the invention, the positive pressure created inside the mold during the compression action forces the wet foam to flow into void spaces within the mold, and forces liquid to flow through the porous platen to relieve excess pressure and form a. molded cellulose foam having a smooth, dense surface fiber layer and a low density, open-cell structure interior.

In an embodiment, the invention relates to a wet cellulose fiber foam press comprising a lower platen assembly comprising a first rigid grid through which liquid can pass set on a flat surface and at least one first perforated sheet through which only liquid can pass set on top of the first rigid grid, a solid frame forming a molding chamber set on top of the first perforated sheet, and an upper platen assembly comprising a second perforated sheet through which liquid can pass with and at least one second rigid grid through which only liquid can pass set on top of the second perforated sheet, wherein the molding chamber comprises a mold inserted into the molding chamber or as part of the solid frame, and wherein the lower and/or the upper platen assembly may further comprise a first or second perforated sheet through which only liquid can pass. In some embodiments of the invention, the first and/or second rigid grid in the wet cellulose fiber foam press is acrylic plastic, polymethyl methacrylate, polycarbonate, polypropylene, polyethylene terephthalate, polyvinyl chloride, acrylonitrile-butadiene-styrene, metal, wood, or terracotta. In some embodiments of the invention, the first and/or second perforated sheet in the wet cellulose fiber foam press is acrylic plastic, polymethyl methacrylate, polycarbonate, polypropylene, polyethylene terephthalate, polyvinyl chloride, acrylonitrile-butadiene-styrene, metal, or silk. In some embodiments of the invention, the wet cellulose fiber foam press further comprises at least one first screen through which only liquid can pass located between the first rigid grid and the first perforated sheet through which only liquid can pass, and/or a second screen through which only liquid can pass located between the second rigid grid and the second perforated sheet. In some embodiments of the invention, in the wet cellulose fiber foam press the first and/or second screen is acrylic plastic, polymethyl methacrylate, polycarbonate, polypropylene, polyethylene terephthalate, polyvinyl chloride, acrylonitrile-butadiene-styrene. In some embodiments of the invention, the solid frame in the wet cellulose fiber foam press is wood, metal, or plastic.

In an embodiment, the invention relates to a method for molding a wet fiber foam using the wet cellulose fiber foam press of the invention comprising stacking the solid frame forming a molding chamber on top of the lower platen assembly, overfilling the molding chamber with the wet fiber foam, lowering onto the wet fiber foam the upper platen assembly, to create a molded fiber foam with a smooth, dense surface fiber layer and a low density, open-cell structure interior, and optionally drying the molded fiber foam. In some embodiments of the invention, the wet foam used in the method for molding a wet fiber foam has a compressive strength greater than about 1.5 kPa.

The singular terms “a”, “an”, and “the” include plural referents unless context clearly indicates otherwise. Similarly, the word “or” is intended to include “and” unless the context clearly indicates otherwise.

Mention of trade names or commercial products herein is solely for the purpose of providing specific information or examples and does not imply recommendation or endorsement of such products.

It was surprising to the inventors that the molded fiber foams produced with the press of the invention presented with a smooth, dense surface fiber layer and a low density, open-cell structure interior. The compression press of invention may be used to prepare molded cellulose fiber foams using wet cellulose fiber foams prepared by any method known in the art.

The wet fiber foam may be made from aqueous softwood pulp fiber mixtures and sodium dodecyl sulfate (SDS) as a foaming agent. Polyvinyl alcohol (PVA) may be added as a fiber dispersant and foaming aid in formulations with fiber concentrations greater than 7%. A blender and a planetary paddle mixer may be used to make foam containing fiber concentrations ranging from 0.77% to 11% and from 14.1% to 23.3%, respectively. The wet foam compressive strength was positively correlated with the drying time, dry density, compressive strength, and modulus. A wet foam compressive strength greater than 1.5 kPa was required for compression molding foam panels. The process involved overfilling (135%) the mold before lowering the upper platen. As the platen contacted and compressed the foam, sufficient pressure was created for the foam to flow and fill void spaces. Excess foam liquid exuded through the platens as the foam structure collapsed primarily at the platen surface. Compression molding created foam panels with a smooth, dense fiber layer on the surface and a low-density foam interior. The dry foam densities ranged from 0.0062 to 0.075 g/cm³, porosity ranged from 95% to 99.6%, and thermal conductivity ranged from 0.0385 to 0.0421 W/mK.

Some of the wet fiber foams were prepared with the addition of wax to the wet fiber foam, and even at the lowest level of wax addition, the wax-impregnated samples floated on water whereas the control samples, without wax, almost immediately absorbed water, sank, and dispersed/disintegrated. The wax impregnated foam held together when forcibly submersed in water for water submersion tests (30 seconds) whereas the control rapidly dispersed/disintegrated. In fiber foams prepared with wax dispersed in a fiber matrix little wax was needed to provide moisture resistance. The amount of wax added to the foams didn't appear to affect the foam structure and yet the foams went from immediately dispersing in water to floating and holding together when forcibly submersed in water. While paraffin wax essentially made the foam denser, the carnauba wax surprisingly had very little effect on the foam density and yet was effective in conferring moisture resistance. I was not necessary to fill the pores of the foam with wax in order to confer moisture resistance or at least make the foam float on water. It appears that the wax treatment resulted in the wax melting and coating the individual fibers during the oven drying step. Also, the wax probably helped bind fibers together in areas where the individual fibers came in contact with each other. Only a small amount of wax was needed while still maintaining the foam structure intact. The foam structure appeared similar to the control structure and yet it was water resistant. Water could be forced into the pores of the foam by forcing the foam under water rather than letting it float. Still, the wax was capable of preventing the foam from dispersing/disintegrating in water as with the untreated control.

As used herein, the term “fiber” refers to a complex carbohydrate generally forming threads or filaments, which as a class of natural or synthetic materials, have an axis of symmetry determined by their length-to-diameter (L/D) ratio. Fibers may vary in their shape such as filamentous, cylindrical, oval, round, elongated, globular, or combinations thereof. The size of a fiber may range from nanometers up to millimeters. Natural fibers are generally derived from substances such as cellulose, hemicellulose, pectin, and proteins. The fiber component in the novel foams of the invention may be at least one of a plant-derived complex carbohydrate, a crop waste fiber, a wood, a lignocellulosic fibrous material, a fiber crop, or a combination thereof.

As used herein, the terms “foaming agent” and “surfactant” are used interchangeably and refer to a substance which tends to reduce the surface tension of a liquid in which it is dissolved, increasing its spreading and wetting properties. Surfactants may act as detergents, wetting agents, emulsifiers, foaming agents, or dispersants. chemical which facilities the process of forming a wet foam and enables it with the ability to support its integrity by giving strength to each single bubble of foam. The concrete industry utilizes foaming agents for making cellular concrete. Such foaming agents may also be used for making cellulose foams. These foaming agents include hydrolyzed protein formulations as well as proprietary synthetic formulations. A foaming agent for use in the preparation of the foams of the invention may be anionic, cationic, or non-ionic. Some well-known surfactants that can be used as foaming agents may include alkyl sulfates such as sodium dodecyl sulfate (SDS), alkyl ether sulfates such as sodium lauryl ether sulfate (SLES), polysorbates such as TWEEN, monoglycerides, sorbitan fatty esters, and mixtures thereof.

As used herein, the term “binder” refers to a compound that adheres solid constituents together to form a heterogeneous mixture of different components. Proteins and carbohydrates are commonly used as binders in the preparation of cellulose foams.

As used herein, the terms “wax” and “wax binder” are used interchangeably and refer to a solid substance consisting usually of hydrocarbons of high molecular weight, and may contain other derivative compounds such as carboxylic acid, esters, aldehydes, ketones, etc. A wax may be of mineral origin (such as ozokerite or paraffin wax) or may be one of numerous substances of plant or animal origin that differ from fats in being less greasy, harder, and more brittle, and in containing mainly compounds of high molecular weight (such as fatty acids, alcohols, and saturated hydrocarbons). Waxes may be synthetic waxes, or natural waxes. Natural waxes may be derived from plants, insects, or animals. Examples of natural waxes are carnauba wax, candelilla wax, beeswax, tallow, jojoba wax, lanolin, ambergris, soy wax, rice bran wax, and laurel wax. Synthetic, low molecular weight polyesters such as polycarpolactones, polylactic acids, polyhydrobutyrates, polybutylene succinates may also be considered waxes.

As used herein, the term “waxy starch” refers to a starch with about 100% amylopectin. This is different from the conventional definition of wax as used by default here.

As used herein, the term “dispersant” relates to any compound that when used in an aqueous environment facilitates the separation of fibers which normally tend to agglomerate into clumps or masses. In the presence of dispersant, the fibers and fillers are uniformly dispersed. The dispersant is normally a high molecular weight polymer compound. The dispersant is water soluble and has high viscosity in aqueous solution.

The clumping or agglomerating of fibers produces a heterogenous mixture and results in a weaker foam structure. Properly separating fibers using dispersants in an aqueous environment produces better intermeshing and overlapping of individual fibers and produces a strong fiber foam structure. In certain formulations a foaming agent may serve as a dispersant, in these formulations addition of an additional dispersant agent is not always necessary.

The term “effective amount” of a compound or property as provided herein is meant such amount as is capable of performing the function of the compound or property for which an effective amount is expressed. As is pointed out herein, the exact amount required will vary from process to process, depending on recognized variables such as the compounds employed, and the various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skill in the art using only routine experimentation.

The term “matrix” as used herein refers to a dispersion of fiber that is intercalated with other substances such as at least one binding wax, at least one foaming agent, and/or at least one dispersant. In the matrices described herein the fiber, the at least one binding wax, the at least one foaming agent, and/or the at least one dispersant are distributed throughout a matrix without undesirable agglomeration or separation of fiber, binding wax, foaming agent, or dispersant.

The terms “ ”optional” and “optionally” are used interchangeably herein and mean that the subsequently described substance, event, or circumstance may or may not occur, and that the description includes instances in which the described substance, event, or circumstance occurs and instances where it does not. For example, the phrase “optionally at least one dispersant” means that the foam composition may or may not contain an additional dispersant, and that the Examples include compositions that contain and do not contain an added dispersant. In some instances, the foaming agent or wax binder in the foam composition act as dispersants, thus, there is no need to add at least one binder. For example, the phrase “optionally adding at least one binder” means that the method (or process) may or may not involve adding an additional binder and that this description includes methods (or processes) that involve and do not involve adding an additional binder.

As used herein, the term “about” is defined as plus or minus ten percent of a recited value. For example, about 1.0 g means 0.9 g to 1.1 g.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus, the specification includes disclosure by silence (2013, Tom Brody, “Negative Limitations In Patent Claims,” AIPLA Quarterly Journal 41(1): 46-47).

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

Preparation of Wax/Cellulose Composite Foam

To determine the effect of wax on the properties of cellulose composite foam different waxes were used in the preparation of cellulose foams. In this Example, different wax binders were explored along with shellac, and a starch treatment that was included as a comparison.

The procedure described in this Example uses a blender in a method of making foam compositions. This method typically uses more water than the rigid foam method that uses a paddle mixer such as a HOBART or KITCHEN-AID mixer (as in Example 3, below). The foams produced can have very low density and have very good thermal insulative properties. The materials used are listed in the paragraphs below.

Fiber: Southern Bleached Softwood Kraft (SBSK) was obtained from the Columbus, Miss., USA paper mill (International Paper, Global Cellulose Fibers; 6400 Poplar Avenue, Memphis, Tenn., USA). This grade of Southern pine fiber has high brightness, exceptional balance of tear and tensile strength, and provides bulk, making it suitable for a variety of tissue, paper, and packaging applications. This fiber is FDA compliant for food contact. Sample IDs used were CO-SBSK, CXOE05020, 5/5/2020, COLUMBUS.

Foaming Agent: A 29% liquid solution of Sodium Dodecyl Sulfate also known as Sodium Lauryl Sulfate (SDS) was obtained from CHEMISTRYSTORE.COM (The Chemistry Store; 1133 Walter Price St., Cayce, S.C., USA).

Starch: Waxy corn pregel (HIFORM 12744) was obtained from CARGILL, PO Box 9300, Minneapolis, Minn., 55440-9300, USA.

Waxes were obtained from Gulf Wax, Royal Oaks Enterprises; Roswell, Ga., 30076, USA: Paraffin wax with a melting temperature range of 46° C. to 68° C. Soy wax with a melting temperature range of 49° C. to 82° C. Carnauba wax has a melting temperature range of 82° C. The melting temperature range of beeswax is 62° C. to 66° C.

Shellac: Two water soluble shellac formulations were provided by Tony Chuffo of Coriell Associates Inc., Specialty Coatings and Services; 149 Coriell Avenue, Fanwood, N.J., USA. Shellac flakes were purchased from AMAZON (Seattle, Wash., USA).

Silk Screen: A 160 mesh (about 88.5 μm opening) polyester monofilament TERYLENE screen, with a melting temperature of 250° C. to 260° C. was purchased from MS WGO; AMAZON.

Perforated aluminum sheet: A lincane perforated aluminum sheet was obtained from THE HOME DEPOT; Atlanta, Ga., USA.

Plastic Grid: A suspended egg crate light ceiling panel cut to size was obtained from THE HOME DEPOT.

Wood Frame: Made by removing bottom of wood filing box obtained from HOBBY LOBBY; Oklahoma City, Okla., USA.

The materials and amounts used to prepare the different formulations are listed below in Table 1. In brief, 25 g fiber was shredded and added to a blender (BLENDTEC, 75 oz square jar) with warm (60° C.) tap water (approximately 1:70, fiber: water or 1.5% fiber). The mixture was blended for approximately 30 seconds to disperse the fiber in water. The mixture was allowed to stand for about 10 to 15 minutes to hydrate fiber. The hydrated fiber mixture was blended again for 60 seconds and then poured through a 50-mesh screen (about 0.3 mm openings) on which the fiber was deposited. The fiber was rinsed with cool tap water then gathered into a ball and gently squeezed until the fiber: water weight reached 200 g total (25 g fiber+175 g water) to create a moistened fiber.

To prepare a wax/cellulose foam, the moistened fiber was set aside while two hundred grams of cold tap water were added to the blender along with the amount of wax shown in Table 1. The wax was weighed and added to 200 g water. The water/wax mixture was blended on high for 2 minutes to adequately pulverize the wax into a fine powder. The moistened fiber that was set aside earlier was then added to the blender contents. The contents were then blended for 15 seconds. Two grams of SDS was then added to the blender and the contents were blended for an additional 1 minute. The mixture formed a wet foam in which the fiber and wax components were thoroughly dispersed.

To prepare a waxy starch/cellulose foam, the ball of wet fiber (200 g) was added to the blender along with 200 g additional water. A waxy starch powder with about 100% amylopectin was added gradually to the mixture while intermittently blending to avoid the powder from forming lumps. Once the starch was dispersed, 4 g of SDS were added. The higher amount of SDS was needed to achieve adequate foaming due to the anti-foaming effect of starch. The contents were blended for 1 minute. The mixture formed a wet foam in which the fiber and starch were thoroughly dispersed.

TABLE 1
FORMULATIONS

| | | Fiber (g) | Water (g) | Binder | SDS (g) |
|---|---|---|---|---|---|
| Control | | 25 | 375 | 0 | 2 |
| Starch (g) | Low | 25 | 375 | 3.5 | 4 |
| | Medium | 25 | 375 | 7 | 4 |
| | High | 25 | 375 | 14 | 4 |
| Wax (g) | Low | 25 | 375 | 3.5 | 2 |
| | Medium | 25 | 375 | 7 | 2 |
| | High | 25 | 375 | 14 | 2 |
| Shellac (mL) | Low | 25 | 375 | 3.5 | 2 |
| | Medium | 25 | 375 | 7 | 2 |
| | High | 25 | 375 | 14 | 2 |
| Soy (g) | Low | 25 | 375 | 3.5 | 2 |
| | Medium | 25 | 375 | 7 | 2 |
| | High | 25 | 375 | 14 | 2 |

To prepare a shellac/cellulose foam, the ball of wet fiber (200 g) was added to the blender along with 200 g of additional water minus the volume of liquid shellac added as shown in Table 1. Two grams of SDS was added and the contents were blended for 1 minute. To prepare the shellac 3.5 g, 7.0 g, or 14 g of shellac flakes were added to a blender and water was added to bring to 200 g. The mixture was blended for 60 seconds to pulverize the flakes. The ball of moistened fiber (200 g) was added to the blender along with 2 g SDS and blended for 60 seconds.

The fiber foam was poured and/or scooped into the wooden frame assembly depicted in FIG. 2A to FIG. 21. The Soy wax behaved as an anti-foaming agent, so it was not possible to make foam sheets from the soy wax containing foam. To start the assembly, a plastic grid was put on the bottom of the setting as depicted in FIG. 2A. The plastic grid provides support and allows excess liquid to drain out. A lincane perforated aluminum sheet was placed on top of the plastic grid as seen on FIG. 2B. A silk screen was laid on top of the perforated aluminum sheet as seen on FIG. 2C. As shown on FIG. 2D, a wood frame was placed on top of assembly, followed by the addition of two wooden blocks inside of the wooden frame, as stops, as depicted in FIG. 2E. Finally, as shown in FIG. 2F the fiber foam was poured and/or scooped into the wooden frame.

As seen in FIG. 2G, a silk screen sheet was placed on top of the foam, followed by a lincane perforated aluminum sheet, shown in FIG. 211. Lastly, as depicted on FIG. 21, a plastic grid was placed on top of the perforated aluminum sheet. The plastic grid was then pressed down until it contacted the wood spacers. Once the foam was compressed to the thickness of the blocks, a few minutes were allowed for excess liquid to drain out the bottom of the assembly. The wooden frame was then carefully lifted off the assembly, followed by removal of the plastic grid and the perforated aluminum sheet, and finally carefully peeling off the silk screen sheet. A thin knife may then be used to separate and remove the wood blocks. This leaves the top surface and sides of the foam exposed. The compression step described above collapses the foam on the top and bottom surfaces forming a paper-like surface with the foam sandwiched in between.

The foam was then lifted by the bottom perforated aluminum sheet and placed in an oven set at 105° C. Foam samples were removed periodically from the oven to measure weight loss. The foam was dried until there was no further weight loss observed.

The finished, dry foam was low density, with a paper-like coating on the surface. When wax samples were placed in a pan of water, they simply floated on the surface of the water although there was some moisture absorbed into the pores of the foam.

To measure the wet density of the different foams, once the foam was formed, a cup was filled with foam and the weight was recorded in g/cm³. The volume of a cup is 236.6 cm³. The tare weight of the cup was 30.72 g. The foam weight was determined by subtracting the tare weight from the total weight of the foam. The wet density was recorded as the foam weight divided by the volume.

The dry foam was lightweight. The foam did not have enough internal strength to not slightly collapse or shrink. The initial thickness (Ti) of the wet foam and the final thickness (Tf) of the dry foam were measured with a micrometer. The amount of shrinkage was determined by the following formula (1):

Shrinkage (%)=(1−(Tf/Ti))×100 (1)

For the immersion test, cut foam samples (about 18 cm²) were submerged in tap water (20° C.) for 30 seconds. The weight of the foam sample was recorded before (Wi) and after (Wf) the immersion test. The weight gain (%) was recorded using the following formula:

Weight gain increase (%)=(Wf/Wi)×100 (2)

Foam samples approximately 25 mm² were dried in the oven at 105° C. for 2 hours. The samples were then placed in an incubator at 95 to 100% relative humidity (RH) for 48 hours. The percent weight gain was calculated using equation (2).

Foam samples were conditioned to 50% relative humidity for 48 hours prior to testing. This was accomplished by placing the samples in a sealed chamber containing a saturated salt (Mg(NO₃)₂) and a small circulating fan. Compressive strength at 10% deformation was determined in foam samples that were compressed at a rate of 2.5 mm per minute using a universal testing machine (Mark-10 model ESM 303). Compressive modulus, a measure of stiffness, was determined from the linear slope of the stress/strain curve.

### Results

The blender process was very fast and efficient in making fiber foam samples. The foams produced had a small cell size and fiber dispersion was excellent. As seen in Table 2, below, the wet foam density (in g/cm³) was positively correlated with the concentration of binder used in the formulation. The wet foam density was a useful measurement because it was correlated with the final dry density shown in Table 3, below. Soy wax was also tested but not included in the results due to its anti-foaming properties. Very little foaming occurred during mixing of formulations containing soy wax, even when high amounts of SDS (4 g) were used. Starch moderately suppressed foaming with SDS but foaming was adequate when using higher SDS levels (4 g).

TABLE 2
WET FOAM DENSITY (g/cm³)

| | | | | | | | Shellac |
|---|---|---|---|---|---|---|---|
| | | | | | Shellac | Shellac | Dry |
| Binder Amt. | Starch | Paraffin | Carnauba | Beeswax | NF | G | Powder |
| Control (0 g) | 0.244 | 0.244 | 0.244 | 0.244 | 0.244 | 0.244 | 0.244 |
| Low (3.5 g) | 0.27 | — | — | 0.37 | 0.20 | 0.246 | 0.290 |
| Medium (7.0 g) | 0.40 | — | — | 0.45 | 0.198 | 0.289 | 0.269 |
| High (14 g) | 0.57 | — | 0.29 | 0.51 | 0.203 | 0.263 | 0.286 |

The range of density of the dry foams is seen in Table 3. While thermal conductivity tests have not yet been performed, it is anticipated that all of the foam samples will have excellent thermal properties. Thermal conductivity is typically correlated with dry density; the low-density samples having lower thermal conductivity. The control sample containing no binder had the lowest dry density.

TABLE 3
DRY FOAM DENSITY (g/cm³)

| | | | | | | | Shellac Dry |
|---|---|---|---|---|---|---|---|
| Binder Amt. | Starch | Paraffin | Carnauba | Beeswax | Shellac NF | Shellac G | Powder |
| Control (0 g) | 0.026 | 0.026 | 0.026 | 0.026 | 0.026 | 0.026 | 0.026 |
| Low (3.5 g) | 0.025 | 0.032 | 0.026 | 0.072 | 0.023 | 0.026 | 0.040 |
| Medium (7.0 g) | 0.045 | 0.051 | 0.047 | 0.072 | 0.031 | 0.031 | 0.040 |
| High (14 g) | 0.107 | 0.067 | 0.051 | 0.13 | 0.025 | 0.034 | 0.048 |

Due to the excellent fiber dispersion in the high shear mixing from the blender, the fibers were held together most likely by physical intertwining, but also perhaps by some hydrogen bonding. The compression step formed a paper-like coating on the foam which also help hold the samples together. These results show that extremely low-density foams can be made by the high-shear blending method and that some fiber cohesion occurs even without a binder.

The waxy starch binder suppressed the foaming so 4 g SDS were used with starch as the binder. As seen in Table 3, above, the foam density at 3.5 g was comparable to the density of the control. However, the control required only 2 g SDS. Foam density increased with increasing amounts of starch. The density of dry foams containing starch was typically as high or higher than samples containing wax except for beeswax.

Paraffin wax was milled into a powder in water using a blender and mixed with the fiber as described in the procedure section above. After adding 2 g SDS the mixture readily foamed. The paraffin mixture foamed readily and once formed into a sheet and dried, it formed nice, low-density sheets, as seen in Table 3, above. One observation was that during the oven drying step, the foam sheets collapsed slightly and densified. This is understandable since paraffin wax is a pourable liquid above 82° C. Perhaps if the foam were dried at 40° C., the foam would not collapse slightly. The trade-off is that the foam would take longer to dry. It is also noteworthy that the foam absorbed the paraffin into its matrix and the liquid paraffin did not leak from the bottom of the foam.

As seen in Table 3, above, the carnauba wax resulted in the lowest density dry foams of all the binders tested. Even with 14 g of carnauba wax, the dry foam was low density. As with the paraffin wax, the carnauba wax was completely absorbed into the foam matrix. Foams containing carnauba wax did not collapse as much as observed with the foams containing paraffin wax. This may be due to the higher melting temperature of the carnauba wax.

The beeswax had some anti-foaming behavior. As seen in Table 2, the wet density of the foam comprising beeswax was similar to the foam comprising starch and higher than the foams comprising paraffin wax or carnauba wax. As seen in Table 3, the foams comprising beeswax had the highest dry density of all the binders tested. Perhaps adding more SDS as was done with the starch sample would have decreased the wet and dry densities. As with the other wax samples, the fiber matrix effectively absorbed any melted wax during the drying process, even at the 14 g level.

The foams comprising shellac readily foamed. This may be due to the presence of a surfactant in the shellac formulations. The formulations are proprietary, but it seems reasonable that the shellac liquids were emulsions that made them water soluble. With the 14 g sample, there was a residue deposited on the inside of the blender container. It may be that some of the shellac came out of solution during the foaming step while the surfactant that remained contributed to the foaming process. The shellac NF was very low density for all of the concentration levels tested.

As seen in Table 4, below, the shrinkage (%) during oven drying typically increased as the amount of binder increased in the formulation. Except for the beeswax samples where the amount of shrinkage appeared to be inconsistent with dry density. However, as shown in Table 2 above, the wet density data show that these samples didn't foam well which explains how dry density can be high even when shrinkage is low. The carnauba samples had comparatively little shrinkage and relatively low wet density which is consistent with the low dry density values observed. The paraffin and starch samples had similar amounts of shrinkage. The shellac-NF samples had very little shrinkage, even at high concentrations.

TABLE 4
OVEN DRYING (105 C.) SHRINKAGE

| Binder | Starch | Paraffin | Carnauba | Beeswax | Shellac NF | Shellac G | Shellac Flakes |
|---|---|---|---|---|---|---|---|
| Control (0 g) | 24% | 24% | 24% | 24% | 24% | 24% | 24% |
| Low (3.5 g) | 23% | 26% | 15% | 44% | 23% | 24% | 34% |
| Medium (7.0 g) | 33% | 35% | 25% | 34% | 15% | 27% | 31% |
| High (14 g) | 45% | 40% | 15% | 25% | 15% | 31% | 23% |

Table 5 below shows the drying time (in hours) in an oven at 105° C. The fastest drying times were obtained for the control samples that contained no binder and for some of the shellac samples. The longest drying times obtained were for the starch samples. This result is not surprising since starch has a great affinity for water. The drying times for the paraffin samples were slightly longer than those of the control. This is understandable since the higher the amount of paraffin added, the denser the sample became, which would reduce the evaporation rate. The carnauba samples had relatively less shrinkage and densification, and had drying times similar to the control. The beeswax samples had long drying times which is likely due to the densification of the fiber matrix slowing the evaporation rate. The shellac had minimal effect on the drying rate of the samples, and for some samples shellac even seemed to improve the drying rate.

TABLE 5
DRYING TIMES (hours) IN 105° C. OVEN

| Binder | Starch | Paraffin | Carnauba | Beeswax | Shellac-NF | Shellac-G | Shellac Flakes |
|---|---|---|---|---|---|---|---|
| Control (0 g) | 2.5 | 2.5 | 2.5 | 2.5 | 2.5 | 2.5 | 2.5 |
| Low (3.5 g) | 3.0 | 2.8 | 2.5 | 4.5 | 2.0 | 1.9 | 2.2 |
| Medium (7.0 g) | 4.5 | 3.0 | 2.75 | 4.25 | 1.5 | 2.25 | 2.5 |
| High (14 g) | 6.5 | 3.0 | 2.4 | 4.4 | 2.0 | 2.7 | 3.25 |

As seen in Table 6 samples that were completely immersed in water behaved in different ways. The control sample almost instantaneously was enveloped with water and quickly dispersed and lost all structure and form. The low starch sample behaved similar to the control sample but persisted in the water and could be removed after the 30 second test although it did not maintain its shape. The medium and high starch samples absorbed high amounts of water but maintained their shape and could be removed from the water intact. Adding the lowest amount of wax (3.5 g) had a dramatic effect on water absorption compared to the control sample. Increasing the wax content further generally reduced water absorption further but to a lesser degree. All the wax samples floated in the water but still absorbed water during the submersion test. Samples with beeswax absorbed the least amount of water. Surprisingly, the shellac samples absorbed high amounts of water. They seemed to hold their shape while allowing the matrix to fill with water by capillary action. It was difficult to obtain an accurate water absorption value for control samples and low starch samples because they were unstable in water and collapsed.

TABLE 6
WATER ABSORPTION (%) AFTER A 30 SECOND IMMERSION TEST

| Binder | Starch | Paraffin | Carnauba | Beeswax | Shellac-NF | Shellac-G | Shellac Flakes |
|---|---|---|---|---|---|---|---|
| Control (0 g) | 1,595 | 1,595 | 1,595 | 1,595 | 1,595 | 1,595 | 1,595 |
| Low (3.5 g) | 2,217 | 574 | 361 | 44 | 1,531 | 2,342 | 2,162 |
| Medium (7.0 g) | 1,632 | 252 | 329 | 34 | 2,200 | 2,379 | 2,037 |
| High (14 g) | 1,130 | 124 | 348 | 25 | 2,297 | 2,237 | 1,649 |

Following the 30 second immersion test, the samples were allowed to air-dry, and the amount of shrinkage is shown in Table 7. The amount of shrinkage that occurred was very little (less than about 3%) in the samples containing paraffin, beeswax, and carnauba wax. The results show that the samples with wax had very little dimensional change after immersion and dried with only minor shrinkage. The starch samples, however, had a high amount of shrinkage during the drying step. The shellac NF and Shellac G samples absorbed a high amount of water and had a high degree of shrinkage during air drying. The shellac flakes samples absorbed a high amount of water but maintained their shape better. The samples with high amount of shellac (14 g) collapsed less during drying.

TABLE 7
SHRINKAGE AFTER DRYING FROM A 30 SECOND IMMERSION TEST

| Binder | Starch | Paraffin | Carnauba | Beeswax | Shellac NF | Shellac G | Shellac Flakes |
|---|---|---|---|---|---|---|---|
| Control (0 g) | Collapse | Collapse | Collapse | Collapse | Collapse | Collapse | Collapse |
| Low (3.5 g) | 55% | 1.6% | 2.1% | 1.4% | 82% | 64% | 27% |
| Medium (7.0 g) | 37% | 1.5% | 2.2% | 1.8% | 39% | 47% | 42% |
| High (14 g) | 17% | 1.45% | 2.3% | 2.0% | 50% | 37% | 9.5% |

The weight gain of oven-dried foam samples in 100% relative humidity is shown in Table 8 below. The control sample absorbed 26% moisture after being incubated in 100% RH. The paraffin and beeswax treatments decreased the amount of water absorbed at 100% RH. The carnauba wax samples were unusual with a higher amount of moisture absorption. The starch samples had higher moisture absorption than the control.

TABLE 8
WEIGHT GAIN OF OVEN-DRIED FOAM SAMPLES IN 100% RH

| Binder | Starch | Paraffin | Carnauba | Beeswax | Shellac NF | Shellac G | Shellac Flakes |
|---|---|---|---|---|---|---|---|
| Control (0 g) | 26.4% | 26.4% | 26.4% | 26.4% | 26.4% | 26.4% | 26.4% |
| Low (3.5 g) | 27.3% | 24.8% | 33% | 24.9% | 31.3% | 28.7% | 30.7% |
| Medium (7.0 g) | 32.1% | 20.7% | 31% | 23.7% | 30.9% | 29.5% | 24.0% |
| High (14 g) | 31.7% | 17.6% | 34% | 17.5% | 27.6% | 31.9% | 20.9% |

Data for the compressive strength and stiffness (modulus) determined for a soft foam (polyurethane cushion) and for a rigid foam (beaded polystyrene) are shown in Table 9. Where the foam density was determined by volume and weight measurements. Even though the density was similar for both foam samples, the mechanical properties were very different. The polyurethane foam was easily compressed and readily rebounded after compression which makes it useful for cushioning applications. The beaded polystyrene (beaded-PS) foam was rigid with much higher compressive strength.

TABLE 9
SOFT FOAM AND RIGID FOAM COMPRESSIVE
STRENGTH AND STIFFNESS

| | | Compressive | Compressive |
|---|---|---|---|
| Sample | Density (g/cm³) | Strength (kPa) | Modulus (kPa) |
| Polyurethane | 0.0159 | 2.44 (0.435) | 0.306 (0.0196) |
| Beaded Polystyrene | 0.0136 | 64.3 (0.065) | 18.4 (0.945) |

The compressive stress/strain curves for foam samples showed that the beaded-PS had a yield point at approximately 3% deformation. As seen in FIG. 4, after the yield point, the beaded PS foam sample continued to increase in compressive resistance but at a different rate.

The compressive strength (kPa) of foam samples at 10% deformation is shown in Table 10, where the standard deviation is included in parenthesis. As seen in Table 10, the compressive data for the fiber foam samples showed that the foam was similar to the soft polyurethane foam. The strength of the foam samples generally increased as the amount of binder increased from “low” to “high.” At the “high” level, the starch and beeswax samples had the greatest strength. The paraffin and carnauba wax samples had intermediate strength while the shellac NF and shellac G samples had very low compressive strength, even at the “high” level.

TABLE 10
COMPRESSIVE STRENGTH (kPa) OF FOAMS AT 10% DEFORMATION

| Binder | Starch | Paraffin | Carnauba | Beeswax | Shellac NF | Shellac G | Shellac Flakes |
|---|---|---|---|---|---|---|---|
| Control (0 g) | 0.694 | 0.694 | 0.694 | 0.694 | 0.694 | 0.694 | 0.694 |
| Low (3.5 g) | 0.96 | 1.05 | 2.18 | 3.96 | 0.486 | 1.04 | 1.97 |
| Medium (7.0 g) | 3.16 | 3.35 | 3.80 | 4.64 | 1.40 | 1.50 | 1.49 |
| High (14 g) | 21.1 | 5.98 | 4.23 | 26.9 | 0.456 | 1.14 | 3.26 |

The stiffness (modulus) reflected the results of the compressive strength. The compressive moduli (kPa) of foam samples are shown in Table 11, where the standard deviations are included in parenthesis. As seen in Table 11 the modulus generally increased with increasing amounts of binder except for the shellac NF and shellac G samples. The highest moduli were observed for the starch and beeswax samples containing “high” amount of binder.

TABLE 11
COMPRESSIVE MODULI (kPa) OF FOAM SAMPLES

| Binder | Starch | Paraffin | Carnauba | Beeswax | Shellac-NF | Shellac-G | Shellac Flakes |
|---|---|---|---|---|---|---|---|
| Control (0 g) | 0.069 | 0.069 | 0.0694 | 0.069 | 0.069 | 0.069 | 0.069 |
| Low (3.5 g) | 0.0954 | 0.11 | 0.218 | 0.394 | 0.050 | 0.1034 | 0.192 |
| Medium (7.0 g) | 0.315 | 0.335 | 0.384 | 0.444 | 0.134 | 0.152 | 0.15 |
| High (14 g) | 2.11 | 0.598 | 0.423 | 2.69 | 0.0456 | 0.123 | 0.318 |

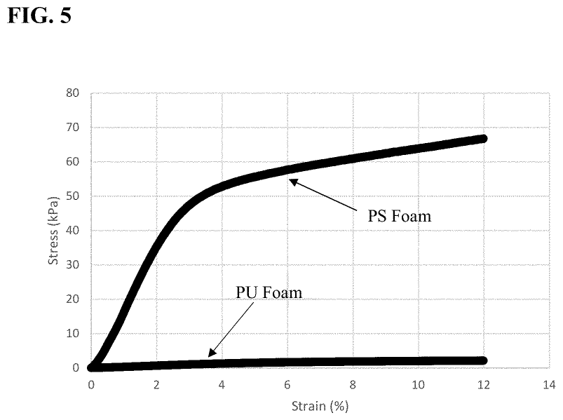

As seen in FIG. 5, the stress/strain curves for the paraffin wax samples show that in contrast to the beaded-PS sample, the stress increases linearly within the strain range tested with no distinct yield point.

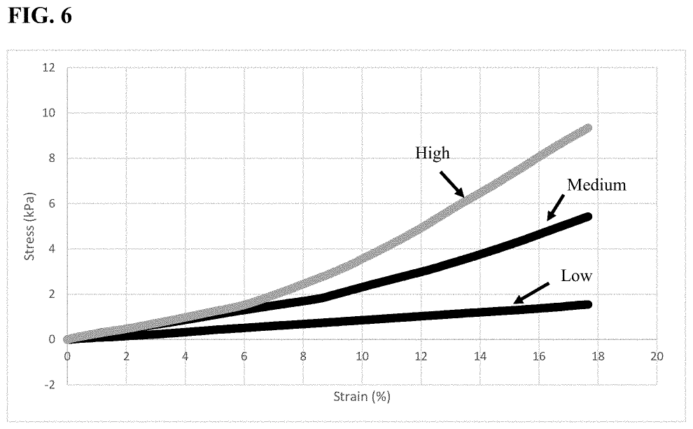

The stress/strain curves for the starch binder are shown in FIG. 6 and show a considerable increase in strength at the “high” level of binder. The increase in strength is most likely due to two factors, densification during drying and the higher amount of binder. This is in contrast to the paraffin wax sample in FIG. 5 that is more or less directly proportionate to the amount of binder.

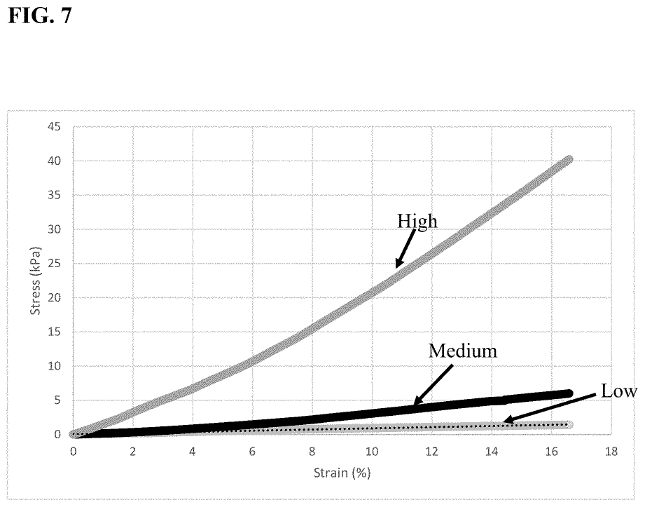

The stress/strain curves for the “high” level of beeswax, starch, and paraffin in comparison to the beaded PS is shown in FIG. 7. The “high” level of beeswax and starch resulted in foam samples that had the highest compressive strength but still not as high as the beaded-PS. The likely reason why the beeswax and starch samples were so strong may be because the density of these samples was also the highest (see Table 3 above). These samples have approximately 10 times the density of the beaded-PS and still have less than half the strength. The paraffin sample had much lower density (Table 3 above) than the starch and beeswax samples which explains its lower strength values.

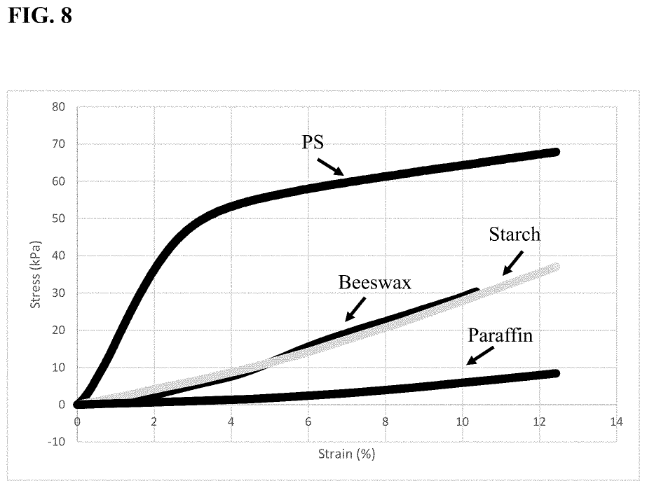

FIG. 8 shows a comparison of the PU foam with the control and two levels of paraffin wax. This figure shows that these foams are in the range for PU cushioning foam.

This Example shows that the fiber foam samples made using the blender technique are most comparable to PU cushioning foam. The density is roughly twice that of PU foam but the mechanical strength for samples containing medium amounts of binder is similar. The paraffin and carnauba waxes are effective in providing moisture resistance without suppressing the foaming ability of the mixture. Beeswax suppresses foaming and creates a denser foam that also has higher strength.

### Example 2

Preparation of High Moisture Foams

This Example describes a method of making foam composition using a blender, as in Example 1. In this Example, foams were prepared with paraffin wax and carnauba wax following the methods taught in Example 1. The foams produced can have very low density and have very good thermal insulative properties

The origin of the materials used are listed in Example 1 above. The materials and amounts used to prepare high moisture foams are listed in Table 1, below. In brief, 25 g fiber was shredded and added to a blender (BLENDTEC, 75 oz square jar) with warm (60° C.) tap water (approximately 1:70, fiber: water, or 1.5% fiber). The mixture was blended for approximately 30 seconds to disperse the fiber in water. The mixture was allowed to stand for approximately 10 to 15 minutes for the fiber to hydrate. The fiber mixture was blended again for 60 seconds, and then poured through a 50 mesh (about 88.5 mm) screen on which the fiber was deposited. The fiber was rinsed with cool tap water, then gathered into a ball and gently squeezed until the weight of the fiber: water reached 200 g total (25 g fiber+175 g water), from hereon called “moistened fiber”.

The moistened fiber was set aside while two hundred grams of cold tap water were added to the blender along with the amount of wax shown in Table 1, below. The wax was weighed and added to 200 g water. The water/wax mixture was blended on high for 2 minutes to adequately pulverize the wax into a fine powder. The moistened fiber that was set aside earlier was then added to the blender contents. The contents were then blended for 15 seconds. The 2 g of SDS was then added to the blender, and the contents were blended for one (1) minute. The mixture formed a wet foam in which the fiber and wax components were thoroughly dispersed.

TABLE 12
FORMULATION AND PROPERTIES OF HIGH MOISTURE FOAMS

| | | Paraffin | | | Carnauba | | |
|---|---|---|---|---|---|---|---|
| Sample | Control | 1 | 2 | 3 | 1 | 2 | 3 |
| Fiber (g) | 25 | 25 | 25 | 25 | 25 | 25 | 25 |
| Water (g) | 375 | 375 | 375 | 375 | 375 | 375 | 375 |
| 5% PVOH (g) | 0 | 0 | 0 | 0 | 0 | 0 | 0 |
| SDS (g) | 2 | 2 | 2 | 2 | 2 | 2 | 2 |
| Wax (g) | 0 | 3.5 | 7.0 | 14 | 3.5 | 7.0 | 14 |
| Density (g/cm³) | 0.026 | 0.032 | 0.051 | 0.067 | 0.026 | 0.047 | 0.051 |
| Shrinkage (%) | 24 | 26 | 35 | 40 | 15 | 25 | 15 |
| Water Test | Sink/dissolve | Float | Float | Float | Float | Float | Float |
| Water Absorption | 1,595 | 574 | 252 | 124 | 361 | 329 | 348 |
| (wt %) | | | | | | | |

The results showed that addition of wax during foam preparation, even at the lowest levels, markedly decreased water absorption compared to the control containing no wax. There was no incremental benefit from adding increasing amounts of carnauba wax. However, incremental increases in the amount of paraffin reduced water absorption during the water absorption test. Foam samples containing paraffin were denser that samples containing carnauba wax. All of the samples containing wax floated in water, whereas the control foams quickly absorbed water and disintegrated.

The information given in this example shows that even small amounts of wax added during foam preparation are enough to provide a significant benefit in moisture resistance.

### Example 3

Preparation of Low Moisture Foam Formulations

This example describes a method of making foam compositions comprising fiber, water, PVA, SDS, and optionally paraffin wax or carnauba wax using a paddle mixer such as a HOBART or KITCHEN-AID mixer.

The materials and amounts used to prepare low-moisture foams are listed in Table 2, below. In brief, 25 g fiber was shredded and added to a blender (BLENDTEC, 75 oz square jar) with warm (60° C.) tap water (approximately 1:70, fiber: water or 1.5% fiber). The mixture was blended for approximately 30 seconds to disperse the fiber in water. The mixture was allowed to rest for about 10 to 15 minutes to hydrate the fiber. The hydrated fiber mixture was blended again for 60 seconds, and then poured through a 50-mesh screen on which the fiber was deposited. The fiber was rinsed with cool tap water, then gathered into a ball and rigorously squeezed until the total weight was reduced to 75 g total (25 g fiber+50 g water). The fiber ball was placed into a mixing bowl.

Two hundred grams of cold tap water were added to a blender along with the amount of wax shown in Table 13. The wax was weighed and added to 200 g water. The water/wax mixture was blended on high for 2 minutes to pulverize the wax into a fine powder that floated on the water. The pulverized wax was collected on a 50-mesh screen.

The fiber ball was placed in a KITCHEN AID mixing bowl, 50 g of a 5% solution of polyvinyl alcohol (PVA) was added to the mixing bowl along with 2 g of the SDS solution, and pulverized wax in the amounts shown in Table 13. The contents were mixed with a paddle attachment starting at speed 3 and increased gradually to speed 10. Although the moisture content was low, the mixture slowly began to produce a foam. The mixture was stirred for approximately 10 minutes creating a foam that was approximately five times the original volume. Following the procedure of Example 1, the foam was formed into a sheet approximately 2.54 cm in thickness, and dried in an oven at 105° C. until there was no further weight loss.

TABLE 13
FORMULATION AND PROPERTIES OF LOW MOISTURE FOAMS

| | | | Carnauba | | |
|---|---|---|---|---|---|
| Sample | Control | Paraffin | 1 | 2 | 3 |
| Fiber (g) | 25 | 25 | 25 | 25 | 25 |
| Water (g) | 50 | 50 | 50 | 50 | 50 |
| 5% PVA (g) | 50 | 50 | 50 | 50 | 50 |
| SDS (g) | 2 | 2 | 2 | 2 | 2 |
| Paraffin Wax (g) | 0 | 3.5 | 0 | 0 | 0 |
| Carnauba Wax (g) | 0 | 0 | 3.5 | 7.0 | 14 |
| Density (g/cm³) | 0.036 | 0.052 | 0.039 | 0.038 | 0.043 |
| Shrinkage (%) | 3.5 | 28 | 0 | 0 | 3 |
| Water Test | Sink/dissolve | Float | Float | Float | Float |
| Water Absorption | 1,750 ± 0.36 | 165 ± 40 | 1,317 ± 17 | 1,296 ± 54 | 1,238 ± 60 |
| (wt %) | | | | | |

The results of this Example show that the low moisture formulations have very little shrinkage compared to the high moisture formulations of Example 1 and Example 2. All of the wax-containing samples floated in water during the immersion test, whereas the control samples quickly absorbed water and disintegrated. Even though the wax-containing samples absorbed water, they did not quickly disintegrate in water. Only the paraffin wax sample resisted moisture absorption. The carnauba wax samples floated on water but absorbed many times their weight in water during the 30 second immersion test. In contrast, carnauba wax samples in Example 1 had a markedly reduced amount of water absorption. The difference in absorption properties may stem from the use of PVA in this example.

The results of this Example demonstrate that even small amounts of wax can confer moisture resistance and allow the foam to float on water. When the samples are forced under water during the immersion test, the samples absorb water, but they don't disintegrate as does the control sample.

### Example 4

Foam Materials Comprising Fiber and SDS

Foam samples were prepared with different amounts of fiber and SDS, with or without PVA. Samples prepared using a blender were given a “B” designation and samples prepared using a planetary mixer were given a “P” designation.

Pulped softwood fiber sheets were purchased from International Paper (Global Cellulose Fibers, Memphis, Tenn., USA). The fiber was a Southern bleached softwood Kraft obtained from the Columbus, Miss., USA paper mill with a fiber length ranging from 3.8 to 4.4 mm. Reagent grade sodium dodecyl sulfate (SDS, Cas 151-21-3) was purchased from Thermo Fisher Scientific (Waltham, Mass., USA). Polyvinyl alcohol (PVA, Selvol 540, 88% hydrolyzed, 12% acetate, MW=120,000) was purchased from Sekisui Chemical (Pasadena, Tex., USA). Heat moldable perforated (hole size ˜1.5 mm) sheets of polycaprolactone (PCL, Perforated Proto Plast) were purchased from Douglass and Sturgess (Richmond, Calif., USA).

Two different types of mixers (blender, planetary mixer) were used to make foam samples with different fiber contents. For both mixing methods, pieces of fiber sheet were weighed and then completely dispersed and hydrated in water. This was done by forming an aqueous fiber slurry in a 2 L blender (Blendtec; Orem, Utah, USA) using warm (60° C.) tap water. The mixture was blended for approximately 30 seconds to disperse the fibers and then equilibrated for approximately 15 minutes. The fiber mixture was blended again for 30 seconds and then poured onto a screen (50 mesh) to allow drainage. The fiber was collected from the screen, gathered into a ball, and squeezed to expel excess water for further processing.

The fibers collected from the hydration/dispersion step were added to the blender along with other ingredients in the amounts shown in Table 1, below. The PVA was added as a 5% aqueous solution to samples with reduced water content (B-5 to B-7) to facilitate fiber dispersion. The SDS was added as a 29% aqueous solution. Batch sizes ranged from 227 g for B-7 to 414.5 g for B-3. The B-5 batch, for example, contained 25 g fiber, 250 g water, 50 g of a 5% PVA solution, and 2 g of a 29% aqueous SDS solution. Samples B-2 through B-6 were blended for 30 seconds on the highest setting to form a wet foam mixture. Sample B-7 had the highest fiber and lowest water content and was difficult to mix with the blender. This sample was only able to be made into a foam by pulsating the blender and using a spatula intermittently to wipe down the inner walls of the mixing container. The density of the wet foam was determined using a cup and recording the weight and volume.

TABLE 14
FOAM FORMULATION MATERIALS AND QUANTITIES

| Sample | B-1 | B-2 | B-3 | B-4 | B-5 | B-6 | B-7 |
|---|---|---|---|---|---|---|---|
| Fiber | 0.77 | 1.53 | 3.01 | 5.85 | 7.58 | 8.94 | 11.0 |
| (%) | | | | | | | |
| Water | 99.0 | 98.3 | 96.8 | 94.0 | 91.5 | 89.9 | 87.6 |
| (%) | | | | | | | |
| PVA | 0 | 0 | 0 | 0 | 0.76 | 0.89 | 1.10 |
| (%) | | | | | | | |
| SDS | 0.158 | 0.157 | 0.154 | 0.150 | 0.194 | 0.229 | 0.282 |
| (%) | | | | | | | |

High fiber formulations were more easily foamed using a planetary mixer (Model KSM 90, KitchenAid, Inc.; St. Joseph, Mich., USA) equipped with a 4-quart mixing bowl and fitted with a paddle attachment for mixing. The ball of fibers collected from the dispersion/hydration step were further squeezed to expel enough water so that after adding the PVA solution (50 g) and SDS solution, the desired combined weight of fiber and water shown in Table 15 was achieved. The mixing was started slowly (speed 3) and gradually increased to speed 10. Mixing times varied from 3 minutes for P-1 to 12 minutes for P-5. The desired wet densities of the foam shown in Table 17 were used to determine the mixing time for each batch. Each batch consisted of approximately 200 g. The initial weight of each batch was recorded so that the final moisture content could be adjusted to compensate for water loss during the mixing step.

TABLE 15
FOAM FORMULATION MATERIALS AND QUANTITIES

| Sample | P-1 | P-2 | P-3 | P-4 | P-5 |
|---|---|---|---|---|---|
| Fiber (%) | 14.1 | 19.7 | 20.5 | 21.3 | 23.3 |
| Water (%) | 84.1 | 77.9 | 77.0 | 76.0 | 73.8 |
| PVA (%) | 1.41 | 1.97 | 2.05 | 2.13 | 2.30 |
| SDS (%) | 0.36 | 0.50 | 0.52 | 0.54 | 0.60 |

This example shows that as the amount of water added to the fiber foams of the invention is inversely related to the amount of PVA added.

### Example 5

Molding of Foam Samples

Foam samples were molded using a compression mold assembly shown in FIG. 1 assembled as in FIG. 2A to FIG. 21.

As seen in FIG. 1, a compression mold assembly may consist of upper and lower platen assemblies that allowed drainage during compression. The platen assemblies in this example consisted of three layers; a rigid plastic grid support, a middle layer consisting of a perforated (2 mm holes) sheet of aluminum, and a silk screen layer (110 mesh) that directly contacted the foam. The mold itself consisted of wooden blocks that were assembled into the shape of a rectangle and placed on top of the lower platen assembly. An outer wooden frame was lowered over the mold assembly. The mold was firmly secured against the inside surface of the wooden frame. The mold volume (390 cm³) was calculated from dimensional measurements (14.7 cm×10.2 cm×2.6 cm). The mold was overfilled to 135% (525 cm³) by weighing the appropriate amount of foam as calculated from equation 1 where Dw is the wet foam density.

Dw(g/cm3)×525cm3=g of loaded foam (1)

After loading the mold with excess foam, the upper platen assembly was lowered inside the wooden frame until it contacted the foam, which protruded above the mold. The upper platen was then manually compressed forcing the wet foam to flow downward and fill the void spaces of the mold. At the same time, the compression force caused the foam structure to collapse at the surface of the silk screen layer, creating a smooth, paper-like skin on the upper and lower surfaces of the foam. The upper platen was continually pressed until it contacted the upper surface of the mold. The volume of any liquid that drained by gravity or exuded from the platens during the compression molding step was measured and used to determine calculate drainage percentage (Dr) as calculated in equation 2 and reported in tables 3 and 4.

Dr(%)=100×(liquid collected from platen(g)/total liquid(g)) (2)

Following the compression molding step, the wood frame was raised from the mold. The plastic grid and aluminum sheet were lifted from the upper platen assembly and the silk screen layer was peeled away from the upper foam surface. The mold was disassembled and removed by inserting a thin spatula between the foam and each individual wooden block. The plastic grid from the lower platen assembly was removed leaving the exposed foam supported only by the bottom layer of silk screen and perforated aluminum sheet.

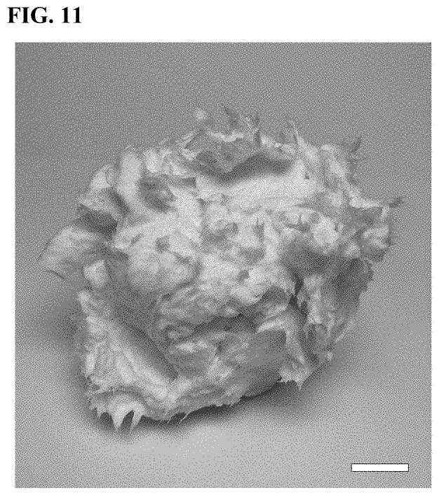

A bottle shape was compression-molded using molds made from perforated sheets of PCL. The bottle mold was made by heating at 90° C. a PCL sheet in the oven until it became pliable. The sheet was removed from the oven and formed around a glass bottle. After the sheet had cooled and become rigid, the glass bottle was removed. The mold was cut out using a band saw. The mold was positioned under the upper platen then pressed into the foam during the compression molding step. The mold was removed from the foam before placing the sample in the oven for drying. FIG. 11 shows a molded bottle shape after drying at 80° C.

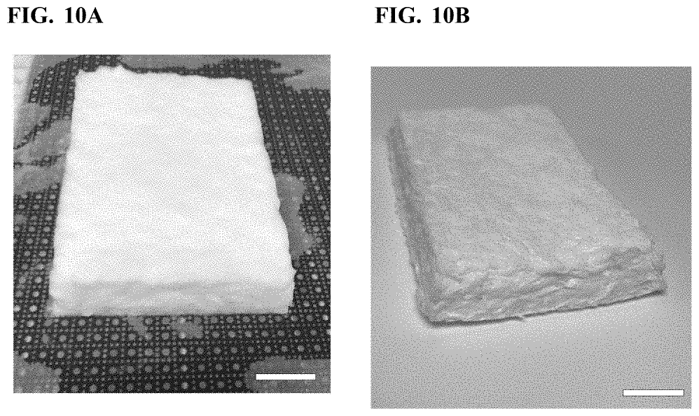

The molded foam samples supported by the underlying perforated aluminum sheet and silk screen layer were placed in an oven and dried at 80° C. The drying time and weight loss were recorded for construction of drying curves. The drying time was recorded as the point when no further weight loss occurred. FIG. 10A shows a demolded sample B-4 after removing from the mold, and FIG. 10B shows the same sample after oven-drying at 80° C.

A Nicolet iS10 FTIR Spectrometer (Thermo Scientific; Waltham, Mass., USA) along with a Smart iTR Diamond attenuated total reflectance (ATR) accessory (Thermo Scientific) was used to characterize the chemical properties of the foam samples, PVA, and cellulose fibers. The surface and center of the foams were examined using the spectrometer. Each IR spectrum contained an average of 64 scans with a resolution of 2 cm⁻¹.

Foam samples were cut into strips of approximately 1.0 cm in thickness to observe the foam structure and porosity. Micrographs were taken using a digital microscope (Dino-Lite model AM3113; Torrance, Calif., USA) equipped with image capture software (Dinocapture 2.0). In some micrographs, back lighting was used to provide higher contrast.

The compressive strength of the wet foam samples was determined using a shear cell consisting of two parts: a cup positioned at the base (8.1 cm inner diameter, 4.4 cm depth), and a cylindrical plunger (7.6 cm diameter). The cup was filled immediately after mixing the foam and the compressive force of the plunger was recorded as it lowered at a rate of 2.5 mm/minute into the cup to a depth of 1.1 cm. The compressive force was measured using a universal testing machine (Model ESM303, Mark-10; Copiague, N.Y., USA).

The compressive properties of dry foams were measured on samples (4.4 cm×4.4 cm) that were cut using a band saw. The samples were conditioned for 48 hours in a chamber with a small circulating fan. The relative humidity of the chamber was maintained near 50% using a saturated salt solution (Mg(NO₃)·6H₂O) as in F. Kawai and X Hu (2009, “Biochemistry of microbial polyvinyl alcohol degradation,” Appl. Microbiol. Biotechnol. 84(2): 227-237). Compression tests were performed using a deformation rate of 2.5 mm/minute. The compressive strength of the dry foam at 20% deformation was measured as per established methods (ASTM D 1621-04a). A minimum of four replicates were made for each treatment.

The dry bulk densities of the fiber foams were determined from volume and weight measurements of oven-dried specimens as per Y. Liu et al (2018, “Comparative study of ultra-lightweight pulp foams obtained from various fibers and reinforced by MFC,” Carbohydr. Polym. 182: 92-97). Helium gas displacement pycnometry (Micromeritics, model AcuPyc II 1340; Norcross, Ga., USA) was used to determine the density (dn) of the foam solids. Porosity (P) was determined from the bulk density of the foams (da) and the density of the foam components (dn) using equation 3, which was obtained from the simple mixing rule with a negligible gas density (Liu et al., 2018). The dn value from gas pyncnometry was 1.51 g/cm³.

P(%)=100×(1−da/dn) (3)

The air uptake volume (Va) was calculated using equation 4 where Vsystem is the volume of the ingredients before foaming and Vair is the volume of the foamed material.

Va(%)=Vair/Vsystem×100 (4)

Percent shrinkage (S) was calculated using equation 5 where Tinitial is the initial thickness of the wet foam and Tfinal is the thickness of the oven-dried foam. Mean thickness of dry foam samples was determined from an average of five measurements.

S(%)=(1−Tfinal/Tinitial)×100 (5)

Thermal conductivity. Thermal conductivity was measured at a mean temperature of 22.7° C. on slab samples for each treatment according to standard methods (ASTM C 177-85) using a thermal conductivity instrument (model GP-500, Sparrell Engineering; Damarascotta, Me., USA). Readings were taken at 1 hr intervals as the instrument approached thermal equilibrium.

An automated respirometer system (Microoxymax, Columbus Instruments; Columbus, Ohio, USA) was used to study the mineralization of the fiber foams as per ASTM methods (D5338) with only minor modification. Fresh compost was purchased from a local hardware store. The material that passed through a 14-mesh sieve (1.4 mm) was collected and stored in a plastic bag overnight for moisture equilibration. Moisture content was determined in triplicate by drying 10 g samples at 105° C. for 16 hours.

Replicate foam samples (P-3) were cut to pieces smaller than 5 mm, and weighed (about 0.5 g) to the nearest 0.1 mg. The samples were added to the respirometry chamber along with compost (about 24.5 g) weighed to 0.01 g. Care was taken to ensure uniform distribution and proper contact of the compost and sample. Water was added to adjust the total moisture content to 58%. Samples were kept for two days at 30° C. then the temperature was raised to 58° C. The CO₂ concentration was measured at 2-hour intervals. Water (2 mL) was added daily to maintain the moisture content range between 50% and 60%. The carbon content of the samples was determined using a CHN Analyzer (Perkin Elmer 2400 Series II; Boston, Mass., USA). The percent biodegradation was calculated as the ratio of the moles of carbon in the sample versus the accumulated moles of CO₂ produced utilizing the ideal gas law as described by SH Imam and SH Gordon (2002, “Biodegradation of coproducts from industrially processed corn in a compost environment,” J. Polym. Environ. 10(4): 147-154).

The fiber foam process takes advantage of the ability of a foaming agent such as SDS to form a stable wet fiber foam composite that can be dried without the foam structure collapsing due to surface tension. In the present study, fiber foams with a wide range of physical and mechanical properties were made using different formulations and two different mixing methods. The blender process was a simple, rapid method of making wet foam from formulations containing 11% fiber or less. Table 16 below shows the mean values of the physical and mechanical properties of wet and dried foam samples prepared using a blender. The values in parentheses denote standard deviations, n=4.

TABLE 16
PHYSICAL AND MECHANICAL PROPERTIES MEAN VALUES

| Sample | B-1 | B-2 | B-3 | B-4 | B-5 | B-6 | B-7 |
|---|---|---|---|---|---|---|---|
| Fiber (%) | 0.77 | 1.53 | 3.01 | 5.85 | 7.58 | 8.94 | 11.0 |
| Dw (g/cm³) | 0.188* | 0.201 | 0.210 | 0.240 | 0.318 | 0.320 | 0.341 |
| Wet Density | (0.0077) | (0.0066) | (0.0042) | (0.0053) | (0.012) | (0.014) | (0.032) |
| Wet Foam | 0.169 | 0.2619 | 0.488 | 1.54 | 3.43 | 5.81 | 11.8 |
| Compressive | (0.0075) | (0074) | (0.064) | (0.110) | (0.065) | (2.13) | (2.15) |
| Strength | | | | | | | |
| (kPa) | | | | | | | |
| Va (%) | 533 | 500 | 481 | 424 | 323 | 322 | 304 |
| | (32) | (21) | (11) | (7.8) | (11) | (12) | (29) |
| Dr (%) | 91.3 | 81.3 | 56.2 | 41.5 | 16.9 | 20.0 | 8.21 |
| Drainage | (2.59) | (1.20) | (5.9) | (3.8) | (1.63) | (188) | (1.32) |
| S (%) | 86.4 | 39.2 | 37.4 | 34.8 | 29.6 | 28.4 | 9.14 |
| Shrinkage | (3.0) | (3.49) | (3.83) | (4.9) | (4.6) | (4.6) | (3.95) |
| Dry time | 16.8 | 30.25 | 65.33 | 129 | 250 | 290 | 337 |
| (min) | (1.24) | (1.26) | (3.3) | (3.0) | (18) | (15) | (16) |
| Da (g/cm³) | 0.0062 | 0.0077 | 0.0156 | 0.0353 | 0.053 | 0.051 | 0.059 |
| Dry Density | (0.0009) | (0.00043) | (0.007) | (0.0019) | (0.0025) | (0.0041) | (0.0041) |
| P (%) | 99.6 | 99.5 | 99.0 | 97.6 | 96.5 | 96.6 | 96.1 |
| Porosity | (0.060) | (0.028) | (0.094) | (0.12) | (0.17) | (0.10) | (3.44) |
| Compressive | 0.065 | 0.162 | 0.89 | 4.52 | 11.5 | 11.2 | 13.6 |
| Strength | (0.039) | (0.045) | (0.25) | (1.31) | (1.64) | (1.72) | (3.11) |
| (KPa) | | | | | | | |
| Modulus | 0.289 | 0.809 | 4.36 | 22.8 | 63.7 | 71.6 | 96.4 |
| (kPa) | (0.150) | (0.23) | (1.16) | (6.78) | (117) | (10.4) | (26.9) |

In contrast, the planetary mixer made it possible to make wet foam samples with more than twice the fiber contents. Interestingly, despite cellulose fiber having a higher density than water, formulations with high fiber contents (P-1 through P-4) had lower wet foam densities than the B-4 to B-7 samples. This result may be due to a greater amount of air incorporation (V a) in the wet foams of the P-series compared to the B series samples. Table 17 below shows the mean values of the physical and mechanical properties of wet and dried foam samples prepared using a planetary mixer. The values in parentheses denote standard deviations, n=4.

The higher air uptake volume (Va) for samples P-1, 2, and 3 compared to the B-7 sample may have accounted for their lower wet foam compressive strength even though they had higher fiber contents (see Table 16 and Table 17). Only samples P-4 and P-5 had higher wet foam compressive strength than the B-7 sample. Samples with fiber contents below 6% (B-1 to B-4) had excessive liquid drainage (Dr). As seen in Table 14, there was no measurable Dr from any of the P-series samples.

TABLE 17
MEAN VALUES OF PHYSICAL AND MECHANICAL PROPERTIES

| Sample | P-1 | P-2 | P-3 | P-4 | P-5 |
|---|---|---|---|---|---|
| Fiber (%) | 14.1 | 19.7 | 20.5 | 21.3 | 23.3 |
| Dw (g/cm³) Wet Density | 0.161* | 0.170 | 0.174 | 0.191 | 0.225 |
| | (0.016) | (0.029) | (0.0070) | (0.0092) | (0.0068) |
| Wet Foam Compressive | 3.94 | 7.84 | 9.72 | 13.15 | 19.8 |
| Strength (kPa) | (0.336) | (1.51) | (4.11) | (1.56) | (1.52) |
| Va (%) | 651 | 622 | 615 | 563 | 481 |
| | (72.5) | (52.5) | (27.1) | (19.3) | (37.2) |
| Dr (%) Drainage | 0 | 0 | 0 | 0 | 0 |
| S (%) Shrinkage | 1.98 | −1.15 | −10.4 | −15.3 | −12.4 |
| | (3.36) | (3.65) | (3.16) | (3.90) | (4.02) |
| Dry time (min) | 184 | 224 | 268 | 338 | 426 |
| | (11.6) | (8.7) | (11) | (9.2) | (15) |
| Dry Density (g/cm³) | 0.0340 | 0.0405 | 0.047 | 0.052 | 0.075 |
| | (0.0022) | (0.0021) | (0.014) | (0.0025) | (0.0035) |
| P(%) Porosity | 97.7 | 97.3 | 96.9 | 96.5 | 95.0 |
| | (0.15) | (0.14) | (0.093) | (0.167) | (0.23) |
| Compressive | 2.55 | 4.00 | 6.04 | 8.26 | 27.2 |
| Strength (kPa) | (0.50) | (1.12) | (1.47) | (1.80) | (3.81) |
| Modulus (kPa) | 12.8 | 20.0 | 30.2 | 41.3 | 135.9 |
| | (2.49) | (5.58) | (7.34) | (9.04) | (19.1) |
| Thermal Conductivity (W/mK)** | 0.0389 | 0.0402 | 0.0421 | 0.0412 | 0.0385 |
| | (0.00174) | (0.00320) | (0.00376) | (0.00107) | (0.00374) |

**Thermal conductivity of beaded polystyrene foam (density = 0.019 g/cm³) was 0.0377 W/mK.

The use of models that correlated wet foam parameters with the physical and mechanical properties of the finished dry foam is valuable in product development. As shown in Table 18, models based on wet strength, wet density, fiber content, and air volume (Va) were correlated with drying time, dry density, compressive strength, and modulus. Linear models for wet density and Va had correlation coefficients greater than 0.91 while models based on fiber content were generally poorly correlated with the targeted parameters. Overall, wet foam strength models had the highest correlation coefficients when compared to linear models for wet density, Va, and fiber content. Linear models were the best fit for drying time and density (Da) while natural logarithm models best fit the compressive strength and modulus data. The results underscore the value of determining wet compressive strength and using models to accurately predict fiber foam properties.

TABLE 18
MODELS AND CORRELATION COEFFICIENTS

| | Drying Time (min) | Density (g/cm³) | Compressive Strength (kPa) | Modulus (kPa) |
|---|---|---|---|---|
| Wet Strength (KPa) | y = 15.8x + 117 | y = 0.0026x + 0.0215 | y = 1.328e^{0.149x} | y = 6.673e^{0.149x} |
| | R² = 0.985 | R² = 0.975 | R² = 0.994 | R² = 0.994 |
| Wet Density (g/cm³) | y = 369x − 391 | y = 0.615x − 0.0635 | y = 388x − 61.9 | y = 1932x − 308 |
| | R² = 0.960 | R² = 0.981 | R² = 0.943 | R² = 0.943 |
| Fiber content (%) | y = 23.7x − 180 | y = 0.0038x − 0.0255 | y = 2.07x − 31.3 | y = 10.3x − 155 |
| | R² = 0.737 | R² = 0.698 | R² = 0.497 | R² = 0.497 |
| Air Volume (Va) | y = −1.40x + 11,110 | y = −0.0002x + 0.185 | y = −0.145x + 94.4 | y = −0.719x + 470 |
| | R² = 0.970 | R² = 0.972 | R² = 0.917 | R² = 0.917 |

The platen design shown in FIG. 1 was effective in shaping foams into foam panels or other shapes. The compressive strength of the wet fiber foams reflected the clamping force needed to close the mold in the compression molding step. Samples B-1, B-2, and B-3 had very low wet foam compressive strengths and were not suitable for compression molding. Even though the mold was overfilled, these samples quickly drained, and the remaining foam tended to adhere to the silk screen layer of the platen assembly. Samples B-4 through B-7, and all the P-series samples had sufficient wet foam compressive strengths for compression molding. Overfilling the mold ensured that sufficient internal pressure was created during the compression molding step to make the foam flow into any void spaces within the mold. In addition, the compression force collapsed the foam structure at the platen surfaces and forced the foam to start exuding through the silk screen layers. The fiber component, however, was essentially unable to pass through the silk screen layer. As a result, a skin of compressed fiber was formed on the top and bottom surfaces of the molded foam during the compression molding step. The foam structure of the sample interior was preserved during the compression molding process.

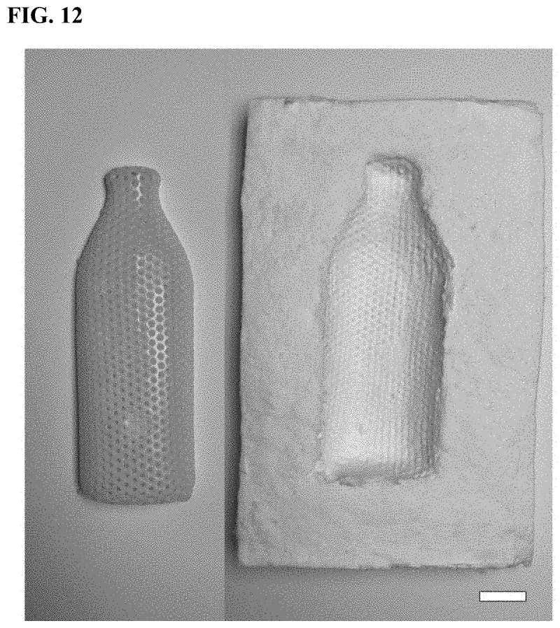

As shown in FIG. 10A and FIG. 10B, photographs of the de-molded wet and dry foam samples from B-4 formulations revealed some dimensional changes to the sample during the drying step due to shrinkage. Shrinkage (S) during drying was highest for formulations with the highest water contents (Table 16). Low moisture formulations such as P-5, a photograph of which is shown in FIG. 11) made a stiff, high wet strength fiber foam that had minimal S during drying and greater dimensional stability, as shown in FIG. 12. These results demonstrated than compression molding of fiber foam was versatile enough to be formed into a wide array of shapes to provide cushioning and/or thermal insulation for specific applications. An alternative method of making foam cushioning for specific products is to simply die cut the desired shape out of foam panels. Multiple panels using cut and uncut panels can be used together to provide proper cushioning and thermal insulation designed for products of different sizes and shapes.

This example shows the range of properties of the molded fiber foams obtained by varying the moisture content of the formulations exemplified in Example 4. The data in this example shows that changing the mixing technique and the amount of water in the formulation allows the preparation of a range of fiber foams from soft fiber foams with very low density, to fiber foams of medium density, to rigid foams.

### Example 6

Foam Drying Conditions

Molded fiber foams prepared in Example 5 using the fiber foams of Example 4 were shaped using a system of for making molded fiber foams as illustrated in FIG. 1

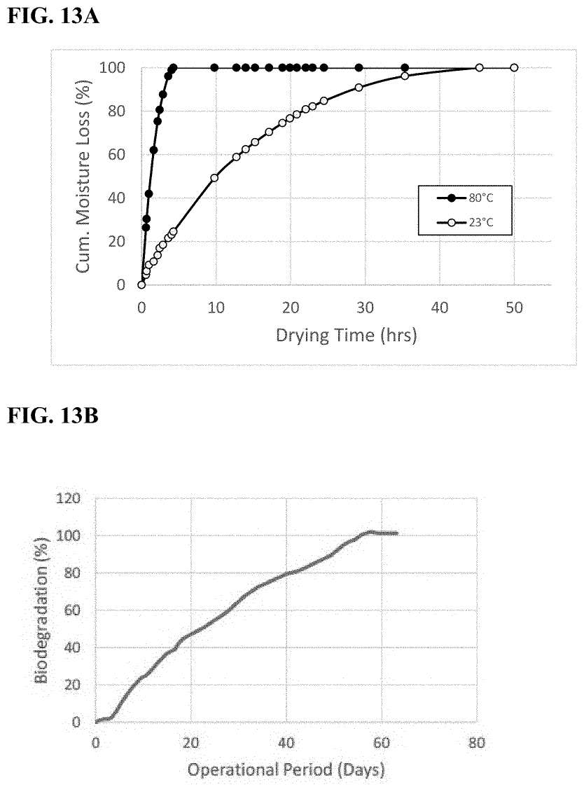

Perhaps the biggest challenge to commercial production of fiber foam is the energy consumption and time required for drying. Foam samples can be dried under ambient conditions to minimize energy costs but then drying times can be excessive. For example, as seen in FIG. 13A, a P-3 sample required two days to dry under ambient conditions whereas the same sample required just over four hours to oven dry at 80° C.

Drying times could be further reduced by drying at temperatures higher than 80° C. However, the upper limit of drying temperature is dependent on the thermal stability of the SDS component. SDS is a non-toxic, anionic surfactant that is readily biodegradable. SDS is approved by the Food and Drug Administration as a food additive and is used in many common household detergents and personal care products. SDS should not be exposed to temperatures above 95° C. for extended periods of time due to its thermal instability. The drying temperature selected for the present study (80° C.) was a compromise between drying rates and the thermal stability limit of SDS.

As seen in FIG. 13B, the respirometry results showed that mineralization of P-3 samples plateaued in approximately 60 days, which is consistent with previous reports (A Mistriotis, et al., 2019, “Biodegradation of cellulose in laboratory-scale bioreactors: experimental and numerical studies,” J. Polym. Environ. 27(12): 2793-2803). The sample reached approximately 100% biodegradation which was unexpectedly high since others report that cellulose typically plateaus between 85-90% mineralization. The minor foam constituents may have influenced the final amount of mineralization. It is also possible that changes in the microbial population and the mineralization of dead microbes skewed the final biodegradation results. Regardless of the microbial population dynamics or other factors, the results clearly indicate that the foam is largely mineralized under normal composting conditions.

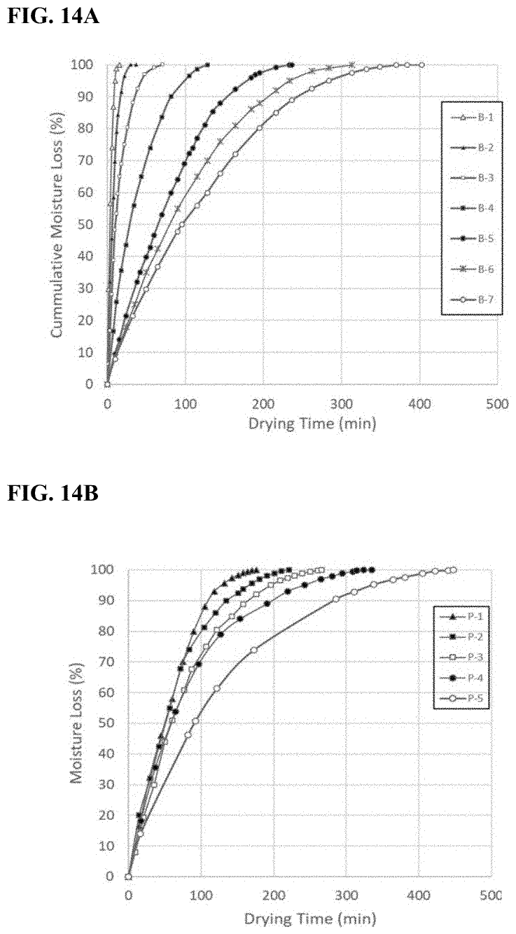

The drying curves for the B-series and the P-series samples are depicted in FIG. 14A and FIG. 14B, respectively, and showed that drying rates were markedly different for each sample. Interestingly, an increase in fiber contents (concomitant decrease in water contents) led to an increase in drying times within each series. Drying times were longer for samples in the P-series that had similar densities to samples within the B-series. For instance, P-1 had a similar dry density (Da) to B-4 but required an additional hour of drying. Not wishing to be bound by theory, it is believed that the difference in drying time could be due, in part, to the disparity in the thickness of the foam samples. The B-series shrank more than the P-series (see Table 16 and Table 17). The longer drying times for the P-series could also be due to their higher fiber contents. Cellulose fiber has an affinity for water and has macro and micropores that are present only when hydrated. During drying, the porous fiber structure gradually shrinks and changes to a nonporous solid as water evaporates first from the large pores and then from the micropores.

The results indicated that fiber content had a greater impact on drying time than the reduction in water content over the range tested. For the P-series, a 165% increase in fiber content from P-1 to P-5 resulted in a 230% increase in drying time (Table 17).

As seen in Table 16, samples with the highest water contents in the B-series had the largest shrinkage (S) due to drying, where S ranged from over 86% in B-1 to less than 10% in B-7 formulations. In contrast, as seen in Table 17, P-1 was the only sample in the P-series with measurable S. Samples P-2 through P-5 had negative S values, meaning that the final thickness of the samples after drying was actually greater than the initial thickness of the wet foam. Although this may seem counter-intuitive, the result can be explained by the swelling that occurred during drying of the samples placed in the oven. The vapor pressure of water at 23° C. is 2.80.4 kPa, and at 80° C. it is 48.04 kPa, as calculated from the Mangus-Tenens equation. The increase in vapor pressure during oven drying likely caused internal swelling of the foam samples as the water vapor initially was unable to evaporate from the foam surface quickly enough to dissipate the internal pressure. The internal pressure coupled with the greater compressive strength of wet foams with high fiber contents may combine to resist the shrinkage in the B-series samples. Observation confirmed that the samples initially swelled after being placed in the oven to dry.

The data in this example shows that of the fiber foam samples prepared in Example 4, samples prepared with the highest water content also dried the fastest. Not wishing to be bound by theory, it is believed that the fiber matrix was more porous in fiber foams made with a high water content, and the porosity of the fiber matrix affected the drying time.

### Example 7

Analyses of the Molded Foams

The physical properties of molded foams prepared with the fiber foams of Example 4 were determined.

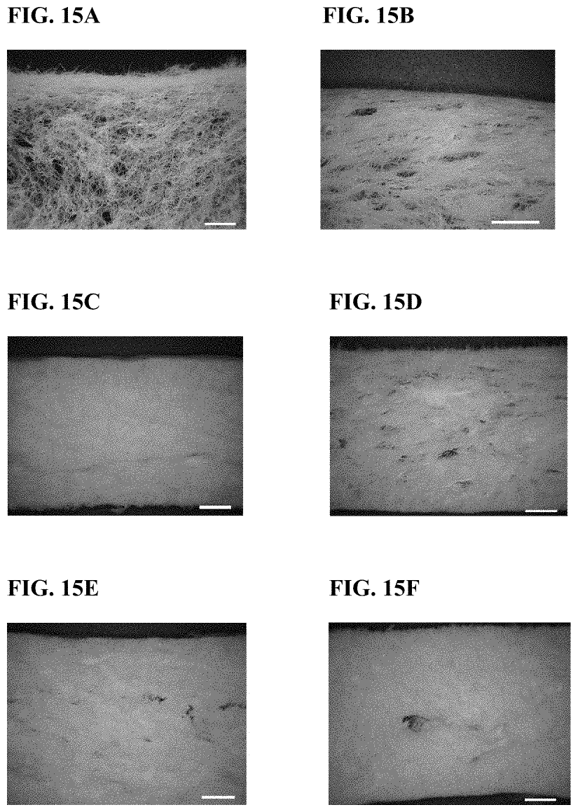

As seen in FIG. 15A to FIG. 15F, micrographs of foam cross-sections revealed different microstructures in the samples. Samples B-1 through B-3 had very low density (Table 16) and, as seen in FIG. 15A and FIG. 15B, a porous, fibrous matrix. In contrast, sample B-7 had a dense fibrous matrix with interspersed small voids (see FIG. 15C). The P-series samples also had small voids distributed throughout their matrices. The P-1 sample had many void spaces (see FIG. 15D), which became progressively fewer in number for samples with higher fiber contents (see the P3 and P-5 micrographs in FIG. 15 E and FIG. 15F). The void spaces likely resulted from localized areas of internal shrinkage during drying. The formation of these internal spaces may account for the relatively low final densities of the P-series samples compared to the B-7 sample.

The addition of a PVA solution (5%) as a fiber dispersant and processing aid was helpful in achieving high fiber foam samples. PVA is a semicrystalline polymer produced by polymerization of vinyl acetate to poly (vinyl acetate) followed by hydrolysis to PVA. Although PVA is water soluble, it is used in the paper industry as a sizing agent to confer grease and oil resistance and provide some moisture resistance. PVA has excellent film-forming properties with good tensile strength, and is used in adhesives, medical devices, and packing films. PVA has low toxicity to humans and biological species in general and is biodegraded by various micro-organisms although at a slow rate.

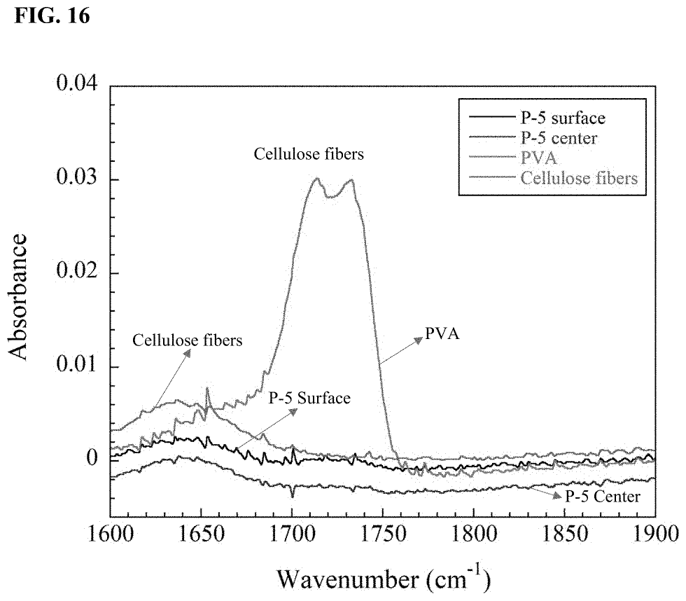

In the present study, PVA not only aided fiber dispersion but also contributed as a binder when included in the foam formulations. Samples containing PVA formed a particularly pronounced skin on the surface compared to samples without PVA. This could have been due to a tendency for the PVA to migrate with the moisture front and concentrate at the surface during drying. AA Mansur et al. (2008, “FTIR spectroscopy characterization of poly (vinyl alcohol) hydrogel with different hydrolysis degree and chemically crosslinked with glutaraldehyde,” Mater. Sci. Eng. C 28(4): 539-548) used FTIR to show that PVA contains a prominent peak at 1730 which is from C═O stretching of acetate groups left in PVA. As seen in FIG. 16, FTIR analysis of the P-5 sample, which contained PVA, showed that the spectra of the surface and interior were very similar to that of softwood cellulose fibers. However, the sample of the P-5 surface skin did show a small peak at 1730 which is consistent with the presence of PVA (Mansur et al., 2008).

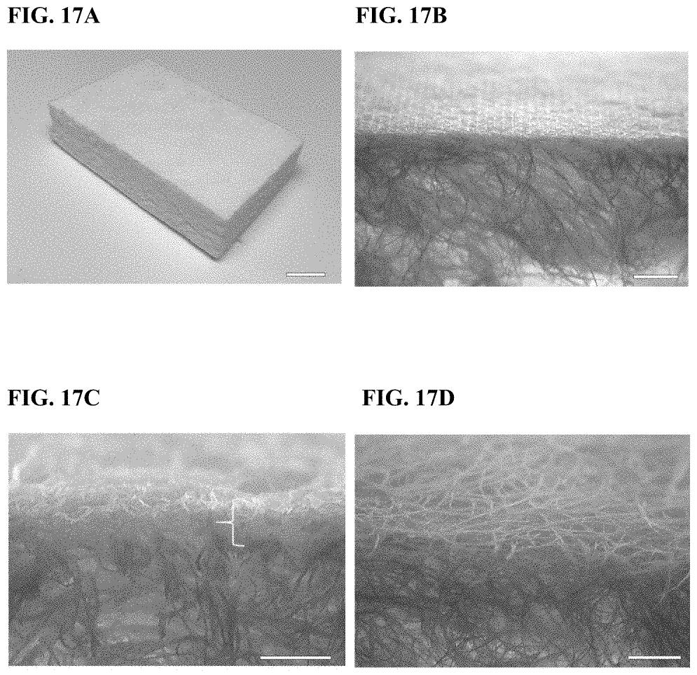

The accumulation of PVA and cellulose fibers in the surface skin was further supported by micrographs of the foam surface. As seen in FIG. 17B, a faint grid imprint from the silk screen was discernible on the surface of the skin from samples containing PVA. Higher magnification of the skin layer containing PVA showed that the underside of the skin was uneven and had a thickness of approximately 100 to 200 μm (FIG. 17C). In contrast, the surface of foam samples without PVA consisted only of a compressed layer of fibers. There was no visible grid pattern imprinted on the surface (compare FIG. 17B and FIG. 17D).

The B-7 and P-5 formulations contained the upper limits of fiber concentrations that still allowed for effective mixing with the blender and planetary mixers, respectively. The results showed that the type of mixer selected for making fiber foams was an important consideration in fiber foam production. In addition to the importance of mixers, batch size within a given mixer type affected the foaming properties of a mixture. For example, batches smaller than 200 g required longer mixing times in the planetary mixer.

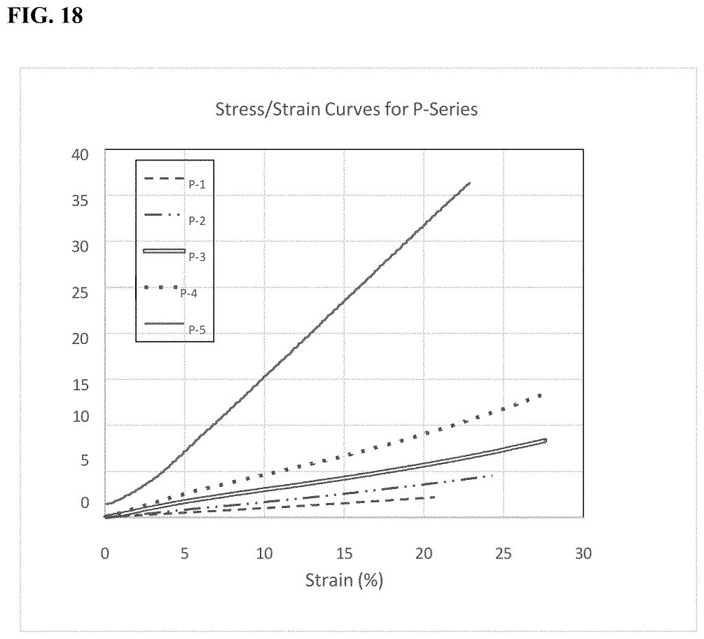

Foams containing greater than 23.3% fiber in the wet formulation were difficult to achieve, although higher fiber concentrations might be possible with other types of mixers. As seen in Table 17, when the fiber concentration was increased from 21.3% (P-4) to 23.3% (P-5), a marked change in the wet and dry foam properties occurred. The P-5 dry fiber foam had approximately three times the compressive strength and modulus of the P-4 sample. As seen in FIG. 18, the stress/strain curves for the P-series showed the dramatic effect of the higher fiber concentration on strength values.

The thermal conductivity values of the P-series foams indicated that the foam had outstanding insulative properties. The values were comparable to the insulative values of beaded polystyrene that had a much lower density (Table 17). The low inherent thermal conductivity of cellulose fiber has been exploited in commercial loose fill and batt insulation (P. L. Hurtado, et al., 2016, “A review on the properties of cellulose fibre insulation” Build. Environ. 96: 170-177). The use of compression molded cellulose fiber foam could be valuable in making molded packaging with excellent cushioning for temperature-sensitive products.

The data in this example shows that molded fiber foams will present different physical properties depending on the moisture level of the wet foam.

We claim:

1. A molded cellulose foam having a smooth, dense surface fiber layer and a low density, open-cell structure interior.

2. The molded cellulose foam of claim 1, wherein the molded cellulose foam comprises a pulped fiber component, at least one foaming agent, optionally at least one binding agent, and optionally at least one filler component;
wherein the pulped fiber component, the at least one foaming agent, the optional at least one binding agent when present, and the optional filler component when present are uniformly dispersed throughout a matrix.

3. The molded cellulose foam of claim 2, wherein the pulped fiber component is crop waste fibers, wood, fiber crops, or combinations thereof.

4. The molded cellulose foam of claim 2, wherein the foaming agent is an anionic, cationic, amphoteric, or nonionic surfactant, or based on synthetic, rosin, protein, or composite compounds.

5. The molded cellulose foam of claim 2, wherein the molded cellulose foam comprises polyvinyl alcohol, a pregelatinized starch, a native starch, a chemically modified starch, carboxymethyl cellulose, a carboxymethyl cellulose derivative, hydroxymethyl cellulose, a hydroxymethyl cellulose derivative, xanthan gum, tara gum, alginate, or gelatin.

6. The molded cellulose foam of claim 1, wherein the molded foam comprises a moisture resistant additive uniformly dispersed throughout the matrix.

7. The molded cellulose foam of claim 6, wherein the moisture resistant additive uniformly dispersed throughout the matrix is a wax emulsion, a rosin emulsion, an alkyl ketone dimer (AKD), an alkyl succinic anhydride (ASA), or a pulverized wax.

8. The molded cellulose foam of claim 1, wherein the molded foam comprises a moisture resistant outer coating applied as a surface moisture barrier.

9. The molded cellulose foam of claim 8, wherein the moisture resistant outer coating is at least one of a plastic film, a wax, AKD, ASA, or a chemically modified carbohydrate.

10. The molded cellulose foam of claim 1, wherein the molded foam is a liner, a packaging material, a shipping material, a food container, or an insulation.

11. The molded cellulose foam of claim 10, wherein the molded foam is a thermal insulation, an acoustic insulation, or an impact insulation.

12. A wet cellulose fiber foam press comprised of a porous upper platen, a porous lower platen, and a mold contained between the upper and lower platens.

13. The wet cellulose fiber foam press of claim 12 wherein the mold is held rigidly in place and when overfilled with a wet foam a positive pressure is created inside the mold during compression action.

14. The wet cellulose fiber foam press of claim 12 wherein the positive pressure created inside the mold during the compression action forces the wet foam to flow into void spaces within the mold, and forces liquid to flow through the porous platen to relieve excess pressure and form a. molded cellulose foam having a smooth, dense surface fiber layer and a low density, open-cell structure interior.

15. A wet cellulose fiber foam press comprising:
a lower platen assembly comprising a first rigid grid through which liquid can pass set on a flat surface and at least one first perforated sheet through which only liquid can pass set on top of the first rigid grid,
a solid frame forming a molding chamber set on top of the first perforated sheet, and an upper platen assembly comprising a second perforated sheet through which liquid can pass with and at least one second rigid grid through which only liquid can pass set on top of the second perforated sheet,
wherein the molding chamber comprises a mold inserted into the molding chamber or as part of the solid frame, and
wherein the lower and/or the upper platen assembly may further comprise a first or second perforated sheet through which only liquid can pass.

16. The wet cellulose fiber foam press of claim 15, wherein the first and/or second rigid grid is acrylic plastic, polymethyl methacrylate, polycarbonate, polypropylene, polyethylene terephthalate, polyvinyl chloride, acrylonitrile-butadiene-styrene, metal, wood, or terracotta.

17. The wet cellulose fiber foam press of claim 15, wherein the first and/or second perforated sheet is acrylic plastic, polymethyl methacrylate, polycarbonate, polypropylene, polyethylene terephthalate, polyvinyl chloride, acrylonitrile-butadiene-styrene, metal, or silk.

18. The wet cellulose fiber foam press of claim 15, further comprising at least one first screen through which only liquid can pass located between the first rigid grid and the first perforated sheet through which only liquid can pass, and/or a second screen through which only liquid can pass located between the second rigid grid and the second perforated sheet.

19. The wet cellulose fiber foam press of claim 18, wherein the first and/or second screen is acrylic plastic, polymethyl methacrylate, polycarbonate, polypropylene, polyethylene terephthalate, polyvinyl chloride, acrylonitrile-butadiene-styrene.

20. The wet cellulose fiber foam press of claim 15, wherein the solid frame is wood, metal, or plastic.

21. A method for molding a wet fiber foam using the wet cellulose fiber foam press of claim 16 comprising:
stacking the solid frame forming a molding chamber on top of the lower platen assembly,
overfilling the molding chamber with the wet fiber foam,
lowering onto the wet fiber foam the upper platen assembly,
to create a molded fiber foam with a smooth, dense surface fiber layer and a low density, open-cell structure interior, and
optionally drying the molded fiber foam.

22. The method of claim 21, further comprising drying the molded fiber foam.

23. The method of claim 21, wherein the wet foam has a compressive strength greater than about 1.5 kPa.
